(19) United States
(12) Patent Application Publication
(10) Pub. No.: US 2015/0129513 A1
(43) Pub. Date: May 14, 2015

(54) Filter System for Heavy-Duty Machine

(71) Applicant: Gilmore Manufacturing, Inc., Carlisle, IA (US)

(72) Inventor: Charles P. Gilmore, Jr., Carlisle, IA (US)

(73) Assignee: Gilmore Manufacturing, Inc., Carlisle, IA (US)

(21) Appl. No.: 14/075,003

(22) Filed: Nov. 8, 2013

(51) Int. Cl. B01D 35/02

(52) U.S. Cl. CPC B01D 35/02
USPC 210/806; 210/323.1; 210/232; 210/85

(57) ABSTRACT

A filter system for a heavy-duty machine includes a filter stand configured to be coupled to the heavy-duty machine. A first filter is supported by the filter stand and is configured to be fluidly coupled to a first fluid flow path that provides pressurized hydraulic fluid to an auxiliary component of the heavy-duty machine, and a second filter is supported by the filter stand and is configured to be fluidly coupled to a second fluid flow path that receives pressurized hydraulic fluid from the auxiliary component of the heavy-duty machine.

### BACKGROUND

The lifeblood of a hydraulic excavator is the hydraulic fluid. If the hydraulic fluid becomes contaminated, the fluid causes dire consequences for the heavy-duty machine and any hydraulic powered work tools associated with the hydraulic system of the machine. Unfortunately, contamination of the hydraulic system on heavy-duty machines is happening more frequently, as more and more excavators are being used in industrial applications.

Industrial applications include specialized market segments of the construction industry such as demolition, scrap/recycling, logging, forestry, sewer and water, pipelines, quarries, railroad services, and heavy construction, along with other less known markets as well. Industrial applications use a variety of hydraulic powered work tools, such as: hammers, shears, pulverizers, compactors, saws, grapples, multi-processors, drills, pile drivers, augers, feller-bunchers, and grinders to mention just a few of the most popular ones. Excavators equipped with hydraulic powered work tools have become the work horses to reduce or eliminate laborious related tasks in these niche markets.

Hydraulic powered work tools, however, are self-destructive because of the daunting tasks they are used to perform. Therefore, if the tools are not closely monitored and maintained, the tools can contaminate the hydraulic system, causing detrimental effects on the longevity of the pumps, valves, tubes, and hydraulic cylinders of the excavator. If a hydraulic system for an excavator becomes contaminated, the machine must be dismantled, flushed, and damaged parts replaced. This can cost in excess of $150,000, depending on the how much time and labor are required, the cost of replacing damaged components, and how long the machine is out of service and hence not generating income revenue.

One very popular hydraulic powered work tool is the hydraulic hammer. The hammer is used to break up large boulders, solid bedrock, and thick slabs of concrete, to mention just a few examples. While accomplishing these duties, the hammer can create up to 700 beeps per minute. These oscillating motions create a significant amount of heat build-up in the hydraulic system of the excavator. If the hammer is used for more than 20 minutes at a time, the hydraulic fluid can reach a temperature of several hundred degrees Fahrenheit. The oil can become so hot that the oil scalds the internal parts of the hammer, causing the parts to deteriorate and contaminate the hydraulic system of the excavator.

The hammer is big and strong, but has two weaknesses that may contribute to the contamination of the hydraulic system of the excavator if not strictly adhered to. First of all, the hammer when working must be greased every 15 minutes or more. If it is not greased regularly, the internal components begin to deteriorate and many of the critical parts begin wearing and the system becomes contaminated. Second of all, the hammer when not on the machine must be placed in an upright stand. When on the machine, but idle, the hammer must be positioned vertically and perpendicular to the ground. Otherwise the bottom seal of the hammer will deteriorate, which will contaminate the hydraulic system of the excavator.

Another example of an excavator hydraulic powered work tool is a hydraulic rotating shear. A hydraulic rotating shear on an excavator is used to cut up I-beams, railroad track and rolling stock (freight trucks, locomotives, freight and passenger cars, and most of the components thereof), ships, containers, heavy equipment, farm tractors and implements, automobiles and trucks, hydraulic cylinders, airplanes, and military items (bombs, tanks, field artillery, aircraft carriers, submarines, and missiles), and parts involving castings, forgings, ferrous and nonferrous metals and all types of steel.

Shearing can be extremely strenuous. Even though a shear can produce over 2,000 tons of cutting force, many times the shear must take time to break through on the strongest pieces of material, like a turret for a tank that is made of armor grade steel. During this time frame an extreme amount of pressure is forced upon the piston of the hydraulic cylinder for the jaw of the shear. When repeated over time, this action causes the cylinder piston rod to weaken and begin flaking, seals to decompose, the hydraulic fluid to deteriorate from the heat build-up, and the hydraulic pump to fatigue from being over exerted. In addition to the standard hydraulic cylinder on the jaw of the shear, some shears are equipped with a speed valve on the jaw cylinder to facilitate hydraulic regeneration, which will further cause accelerated contamination of the hydraulic system if debris is already existent in the hydraulic fluid.

A large shear uses around 400 gallons of hydraulic fluid per minute and operates at around 6,000 psi. So when this amount of hydraulic fluid under this amount of pressure breaks free, the reaction creates a tidal wave (referred to in the industry as a spike) that reverberates through the hydraulic system with the effect of hurling foreign particles and debris against the tubes, hoses, connections, valves and pumps, thereby creating some serious internal component damage and further contaminating the hydraulic system. Another problem involves the rotate circuit of the hydraulic shear. Many excavator operators use the rotate circuit to twist the object that is being sheared. This action causes the internal components of the rotate circuit to begin failing, which will further contaminate the hydraulic system.

Excavator hydraulic powered work tools, such as a large hydraulic rotating shear are heavy (weighing as much as 50 tons), physically large (being 25 feet long, 11 feet high, and 5 feet wide), and hence are cumbersome to install and or remove. Every excavator hydraulic powered work tool has at least one set of steel braided connector lines that are lengthy, stiff, and difficult to handle when connecting and or dis-connecting the hydraulic powered work tool to or from the excavator boom. Therefore, these connector lines are usually left dangling, so the lines are then drug along on the ground when the work tool is being moved to the excavator to be installed, or taken away from the excavator after the work tool has been removed. These actions virtually assure that the oily hydraulic lines will attract and collect foreign debris along the way. It is impossible to totally remove all of the dirt and grime the connector lines collected before the lines are re-connected to the boom of the excavator, and therefore some foreign debris enters into the hydraulic system once the lines are re-connected.

As those familiar with the art can attest, changing excavator hydraulic powered work tools in the field is difficult, time consuming, and accomplished under very unsanitary conditions. This is because most of the time the tools are installed or removed with one or more of the following conditions occurring: it is raining or snowing, it is misting or foggy; the wind is blowing around—dust, dirt, sand, and fiber particles in the air; and the ground the tools are set on is rocky, muddy, snowy, wet, sandy, and/or dusty.

Installing and or removing an excavator hydraulic powered work tool to and from the boom of the excavator manually takes between six to eight hours or more. The difficulty with changing these hydraulic powered work tools necessitated the need for a quick hitch device that could quickly, safely, economically, and environmentally friendly remove or install hydraulic powered work tools in the field. This resulted in the development of several quick connect and disconnect coupler hitches. The quick connect dis-connect couplers have become well known for coupling between the boom of a heavy-duty machine's boom and a stick, such as described in U.S. Pat. Nos. 4,938,651; 5,108,252; 5,199,844; 5,484,250; 5,360,313; 6,301,811; 6,428,265.

These prior known quick connect disconnect hitch devices include the use of hydraulic quick connect disconnect coupling elements, such as a female coupling socket member and a male coupling plug member, for connecting a power source from the boom to a power device on the stick. The quick connect and disconnect quick hitches increase the efficiency and ease to switch hydraulic powered work tools used on a heavy-duty machine, as the hitches and couplers reduce the time for changing tools from several hours to only a matter of minutes. Hydraulic power source quick connect and disconnect couplers also increase the probability that an operator will switch tools on the heavy-duty machine on a routine basis, and therefore increase the probability that the hydraulic system of the heavy-duty machine will become contaminated, especially if the quick connect and disconnect coupling elements are not thoroughly cleaned prior to each coupling maneuver. Quick connect and disconnect couplers therefore drastically increase the probability that an operator will switch tools on the heavy-duty machine, and therefore also drastically increase the probability that the hydraulic system of the heavy-duty machine may become contaminated.

### BRIEF DESCRIPTION OF THE DRAWINGS

For a detailed description of the preferred embodiments of the invention, reference will now be made to the accompanying drawings in which:

FIG. 1 shows a side view of a heavy-duty machine having a boom that is connected by a hydraulic coupler in accordance with one or more embodiments of the present disclosure;

FIG. 2 shows an enlarged side view of the stick and boom of the heavy-duty machine in accordance with one or more embodiments of the present disclosure;

FIG. 3 shows a fragmentary enlarged side view of the coupling on the boom and the stick in accordance with one or more embodiments of the present disclosure;

FIG. 4 shows an enlarged longitudinal sectional view of the male and female coupling members and illustrating a locking mechanism in accordance with one or more embodiments of the present disclosure;

FIG. 5 shows a bottom plan view of the male coupling member showing details of the locking mechanism and the support plates in accordance with one or more embodiments of the present disclosure;

FIG. 6 shows a fragmentary vertical sectional view taken substantially along line 6-6 of FIG. 5 in accordance with one or more embodiments of the present disclosure;

FIG. 7 shows a fragmentary vertical sectional view taken substantially along line 7-7 of FIG. 4 in accordance with one or more embodiments of the present disclosure;

FIG. 8 shows a fragmentary side elevational view of a picker of the male coupling member showing a latch mechanism for locking the pin of the female coupling member in accordance with one or more embodiments of the present disclosure;

FIG. 9 shows a fragmentary side elevational view of the grabber of the male coupling member showing the latch mechanism of FIG. 8 mounted on the grabber in accordance with one or more embodiments of the present disclosure;

FIG. 10 shows a fragmentary side elevational view of the picker of the male coupling member showing a modified latch mechanism in accordance with one or more embodiments of the present disclosure;

FIG. 11 shows an elevational view of the control panel showing in block form in accordance with one or more embodiments of the present disclosure;

FIG. 12 shows an exploded perspective view of the male and female coupling members of a hydraulic coupler in accordance with one or more embodiments of the present disclosure;

FIG. 13 shows a longitudinal sectional view of the roller pin taken substantially along line 13-13 of FIG. 12 in accordance with one or more embodiments of the present disclosure;

FIG. 14 shows an above perspective detailed view of a heavy-duty machine in accordance with one or more embodiments of the present disclosure;

FIG. 15 shows a side perspective view of filters used within a heavy-duty machine in accordance with one or more embodiments of the present disclosure;

FIG. 16A shows an above perspective view of a filter system in accordance with one or more embodiments of the present disclosure;

FIG. 16B shows a front view of the filter system in accordance with one or more embodiments of the present disclosure;

FIG.16C shows an above view of the filter system in accordance with one or more embodiments of the present disclosure;

FIG. 16D shows a side view of the filter system in accordance with one or more embodiments of the present disclosure;

FIG. 17A shows a schematic view of a filter system included within a heavy-duty machine in accordance with one or more embodiments of the present disclosure;

FIG. 17B shows a side perspective view of a filter system included within a heavy-duty machine in accordance with one or more embodiments of the present disclosure;

FIG. 17C shows a front perspective view of the filter system included within the heavy-duty machine in accordance with one or more embodiments of the present disclosure;

FIG. 17D shows a back perspective view of the filter system included within the heavy-duty machine in accordance with one or more embodiments of the present disclosure;

FIG. 18A shows a cross-sectional view of a filter used within a filter system in accordance with one or more embodiments of the present disclosure;

FIG. 18B shows a cross-sectional view of another filter used within a filter system in accordance with one or more embodiments of the present disclosure;

FIG. 19 shows a schematic view of a control panel in accordance with one or more embodiments of the present disclosure;

FIG. 20 shows an above perspective view of a valve of a filter system included within a heavy-duty machine in accordance with one or more embodiments of the present disclosure; and

FIGS. 21A-21C show various hydraulic tools for a heavy-duty machine that may be used with a filter system in accordance with one or more embodiments of the present disclosure.

### DETAILED DESCRIPTION

The following discussion is directed to various embodiments of the invention. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not structure or function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” “higher,” “lower,” and variations of these terms is made for convenience, but does not require any particular orientation of the components.

In one embodiment, the present disclosure relates in general to a filter system for a heavy-duty machine to enable each hydraulic line used on the machine to be filtered individually and at various levels, and more particularly to assure the longevity of the hydraulic components of the heavy-duty machine.

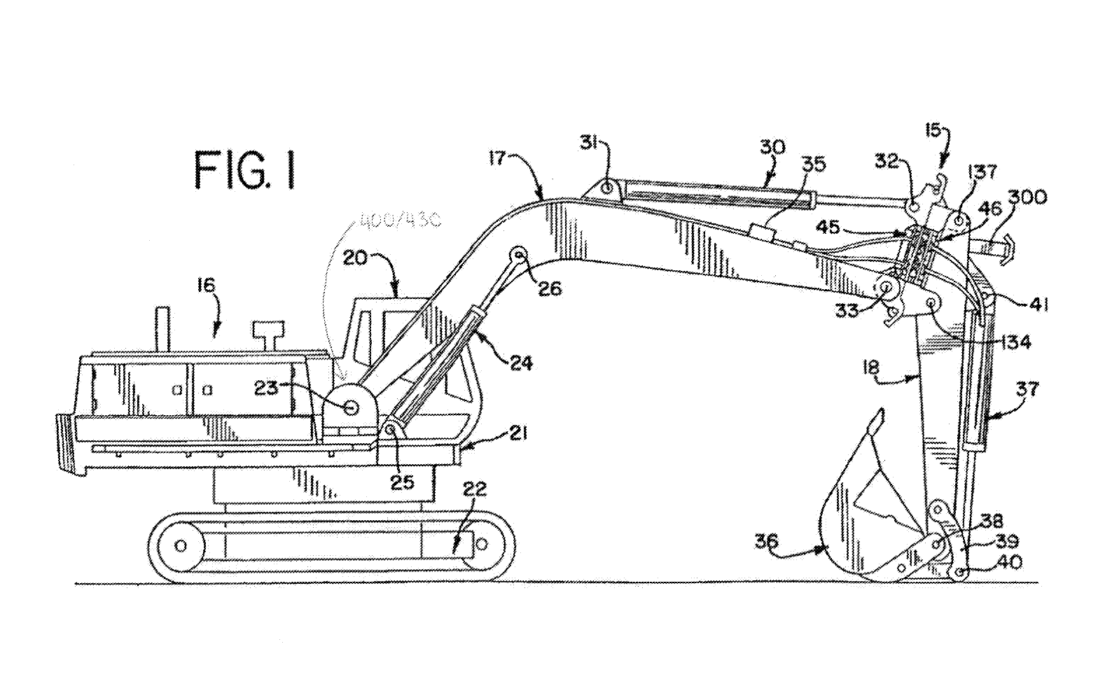

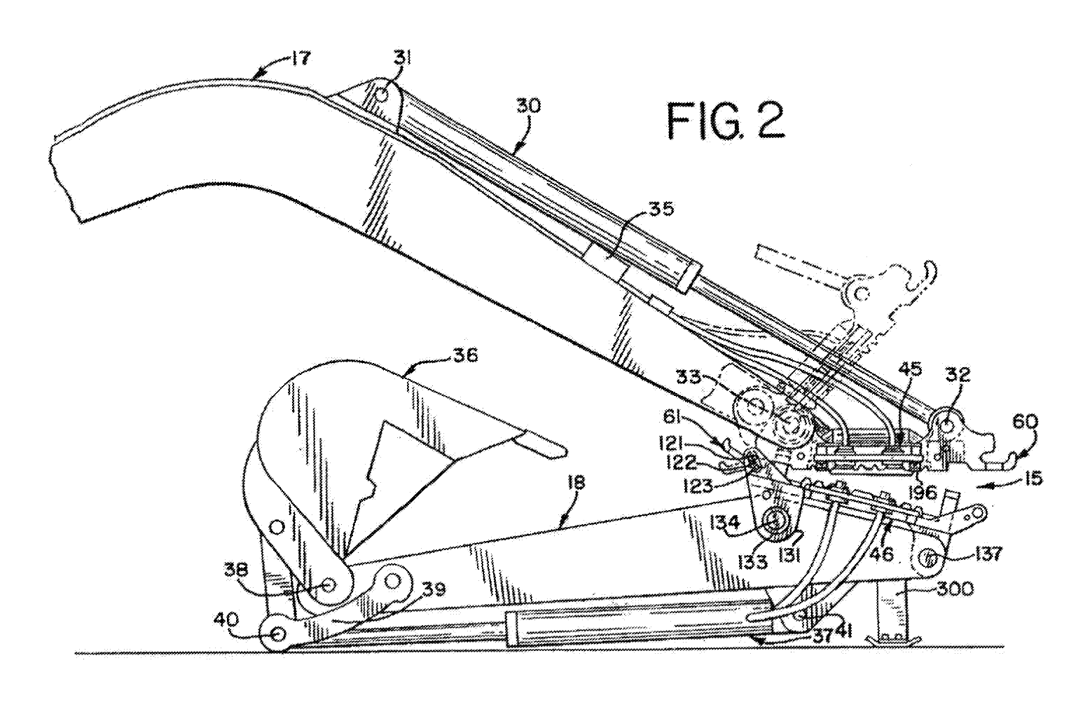

Referring now to the drawings, and particularly to FIGS. 1 to 7, a quick connect and disconnect coupler, such as a hydraulic coupler 15, is shown on a heavy-duty machine 16 having a boom 17 and a stick 18 connecting the stick 18 to the boom 17. One having ordinary skill in the art will appreciate that the quick connect and disconnect coupler may include one or more types of power and/or one or more types of actuators, such as may be hydraulically powered, pneumatically powered, electrically powered, and/or mechanically powered. However, though not to be so limited, the quick connect and disconnect coupler shown within the remainder of the present disclosure is referred to as a hydraulic coupler. The hydraulic coupler 15 may allow for the quick interchangeability of sticks 18 having various tools or working members. The heavy-duty machine 16 may include a cab or operator station 20 on a carriage or base 21, which in turn may be rotatably supported on a track drive 22. While the present disclosure shows a heavy-duty machine having a boom and a stick, it is appreciated that the present disclosure may also be used on other heavy-duty machinery, such as farm equipment, a hydraulic excavator, a back-hoe, or any other heavy-duty machinery where it is desired to have the capability of inter-exchanging tools.

The boom 17 may be pivotally connected at one end 23 to the machine 16 and articulated in a vertical direction by means of a hydraulic cylinder 24 pivotally connected at one end at 25 to the machine base 21 and pivotally connected at the other end 26 to the boom 17 in a known manner. Thus, operation of the hydraulic cylinder 24 swings the boom vertically up or down. The boom 17 may also include on an upper side thereof a stick cylinder 30 pivotally connected to the boom at one end 31 and pivotally connected at the other end 32 to the coupling 15. Thus, the coupling is pivotally connected to the end of the boom at 33.

As shown, the stick 18 may include a bucket 36 and a bucket-operating cylinder 37. The bucket is pivotally connected to the end 38 of the stick 18 and may include linkage 39 that is pivotally connected to one end 40 of the cylinder 37. The other end of the cylinder 37 is pivotally connected to the upper end 41 of the stick 18. It will be understood that the coupling may be coupled while the stick is on the ground and underneath the boom, or while the stick is in the extended position on the ground. Moreover, because the coupling members are symmetrical such that either end may be aligned with each other, the stick may be mounted in an upside-down position.

For purposes of simplicity, not all of the various hydraulic lines are illustrated in the drawings for the hydraulic cylinders and for connecting the hydraulic power source generated by the machine. Further, it should be appreciated that while a stick and boom is shown with a hydraulic coupling, other types of couplings, such as suction, pneumatic or electric, can be used with the present disclosure. It should also be appreciated that while the stick 18 is shown as including a bucket as the working tool, other sticks having other working tools may be provided with female coupling members to be interchangeable so that the heavy-duty machine may serve to easily accomplish different working functions.

The coupling 15 preferably includes a male coupling member 45 and a female coupling member 46, such as the male coupling member 45 connected to the boom 17 and a female coupling member 46 mountable on the stick 18. However, the female coupling member 46 may be connected to the boom 17 and the stick cylinder 30 and the male coupling member 45 may be mounted on the stick 18.

As particularly seen in FIG. 12, the female coupling member 46 may include two parallel and elongated side plates 107 and 108 that are spaced apart and interconnected at opposite ends by transversely extending end plates 109 and 110. At the opposite ends of end plates 109 and 110, teeth or tooth-shaped members 113a and 113b may extend transversely to inter-engage in tooth sockets on the male coupling member 45 formed by frame side plates 49 and 50 to control lateral movement between the coupling members 45 and 46. Further, these tooth-shaped members 113a and 113b may include sockets 114a and 114b for slidably receiving and guiding the wedge-shaped bars 84 and 86 of a locking mechanism 70 on the male coupling member 45.

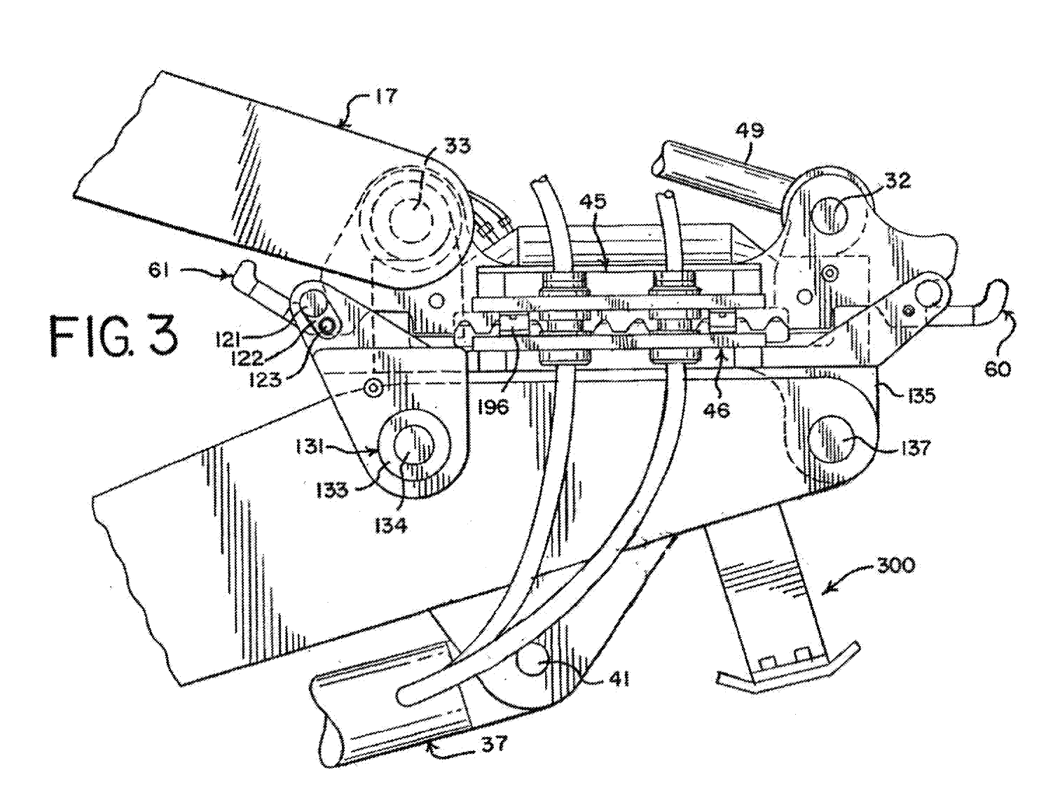

At the top or head end of the female coupling member 46, arms 117 and 118 may extend upwardly from and at an angle to the side plates 107 and 108 and may be provided with one or more aligned holes 120 for selectively receiving the pin 121 that co-acts with the picker 60 during the initial guiding together of the male and female members 45 and 46 during a coupling operation. The pin 121 may be in the form of a roller pin and may include a retaining plate or lug 122 fixed at one end engaging the outside surface of the arm 117 and attachable to the arm by a bolt 123, as shown in FIG. 3. The pin 121 may be positioned or placed within the aligned holes 120 of the arms 117 and 118 such that the lug 122 of the pin 121 may be seen by the operator in the cab 20 to indicate the location of the pin 121 on the female coupling member 46.

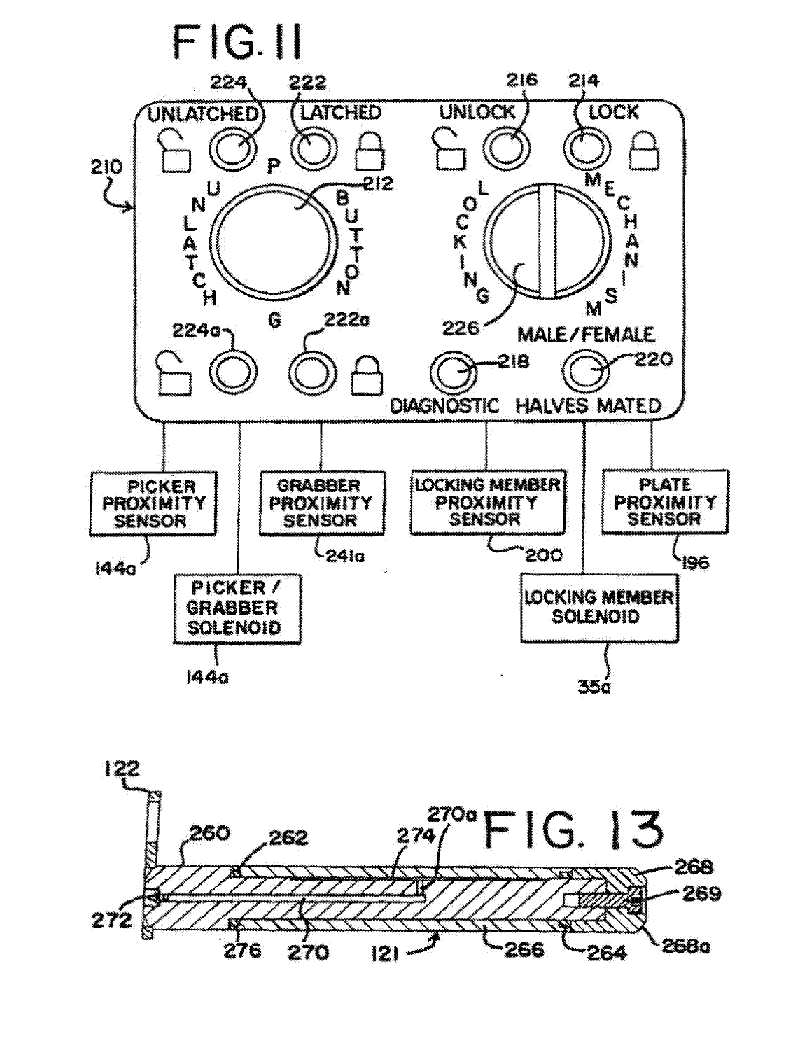

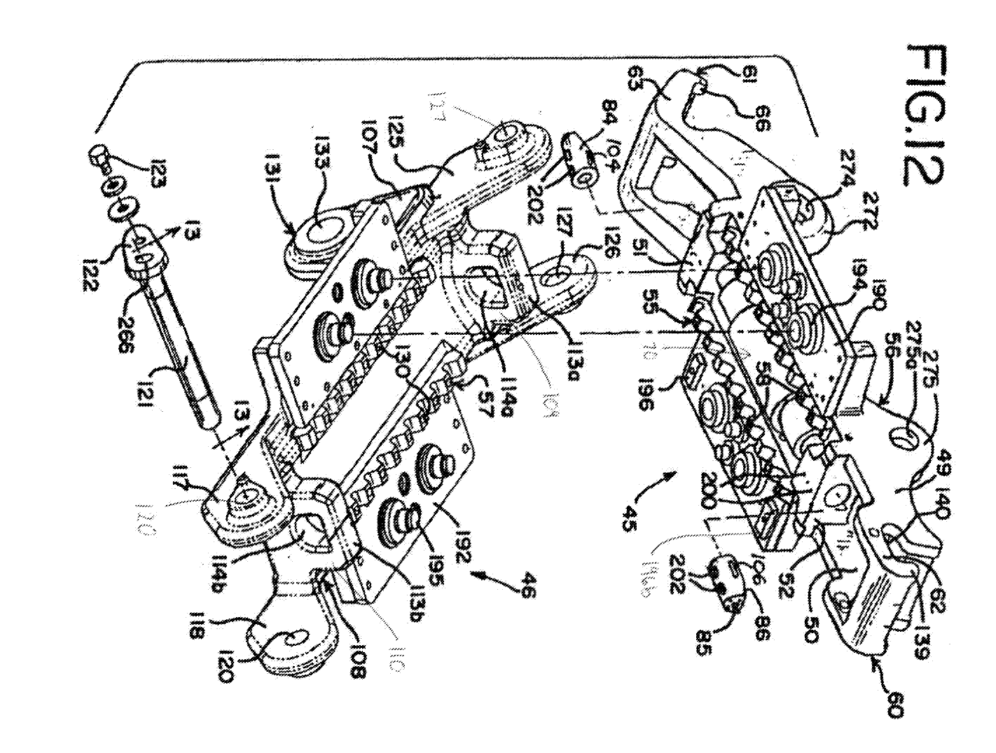

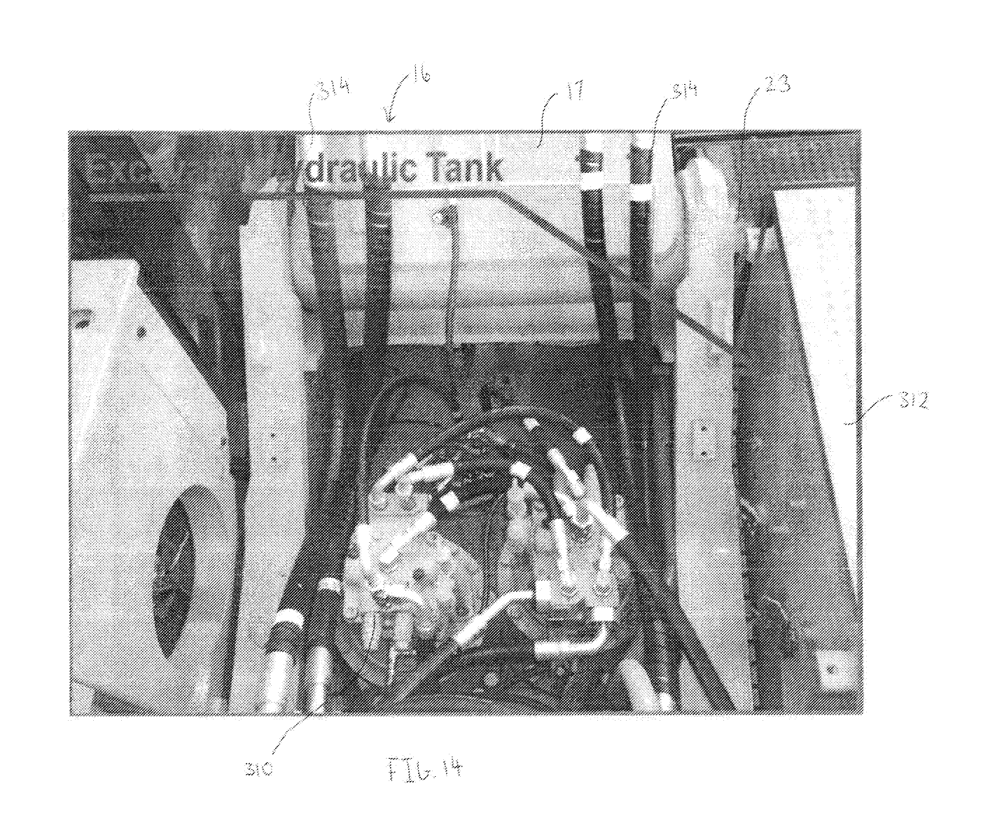

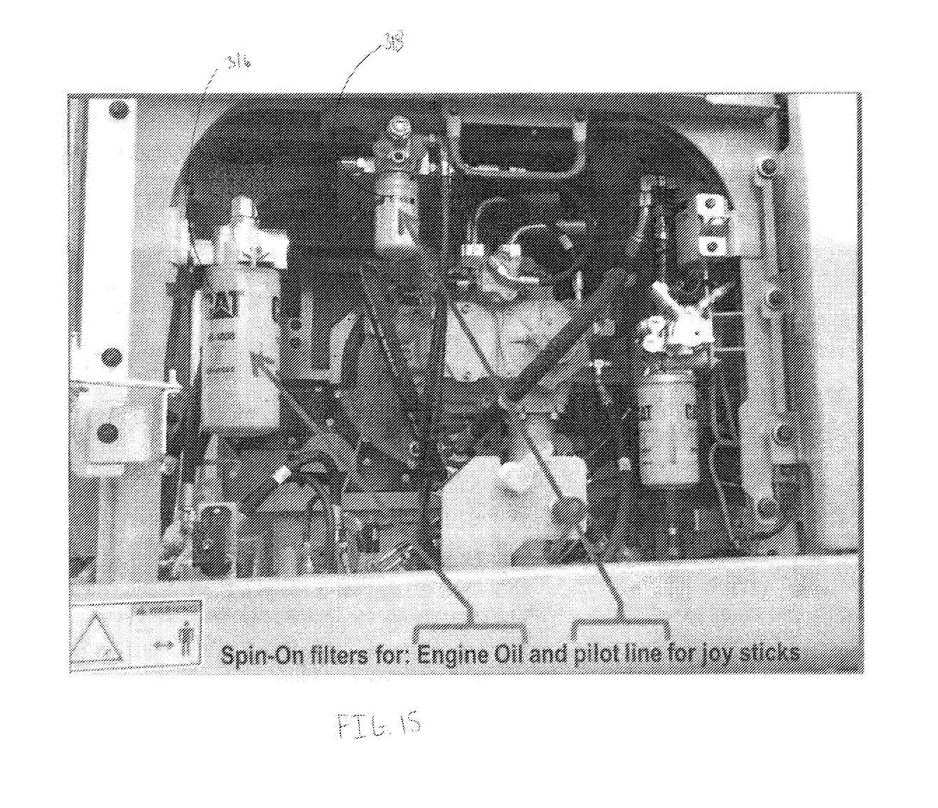

As seen in FIG. 13, the roller pin 121 may include a roller pin cylinder 266 rotatably carried on a pin shaft 260 extending perpendicular to the lug 122. The roller pin cylinder 266 may be maintained on the pin shaft 260 at one end by a shoulder 276 of the pin shaft 260 and at the other end by a cylindrical end cap 268 that is removably connected to the pin shaft 260 by a cap screw 269. The outer surfaces of the pin shaft 260 adjacent to the lug 122, the roller pin cylinder 266, and the end cap 268 are contiguous. While the end cap 268 retains the cylinder 266 on the shaft 260, sufficient tolerances may be provided to allow the cylinder 266 to rotate freely when the end cap 268 is in place. The outer end 268a of the end cap 268 may be beveled to facilitate the insertion of the pin 121 into the aligned holes 120 of the coupling member 46. At opposite ends of the roller pin cylinder 266, annular notches are formed to receive annular seals 262 and 264 that co-act with the pin shaft 260 to seal against loss of lubricant injected between the roller pin cylinder 266 and the pin shaft 260 against contaminants. Grease or lubricant, for example, may be injected between the cylinder 266 and shaft 260 through a zerk or grease fitting 272 at the end of a passageway 270 that axially extends into the center of the pin shaft 260 and communicates through a radially extending hole 270a with a lubricating channel or grease groove 274 formed along a part of outer surface of the pin shaft 260.

In operation, grease or another lubricant may be forced with a suitable grease gun through the grease fitting between the roller pin cylinder and the pin shaft to lubricate the pin and facilitate the rotation of the roller pin cylinder on the shaft. Use of the roller pin thus decreases the amount of wear on the pin and the male coupling member and facilitates the action of joining the coupling members during the coupling operation and separating the members during the decoupling operation.

Alternatively, if it is desired to utilize the grabber 61 to accomplish the initial alignment, the pin 121 may be positioned and/or placed within the pin holes 127 of the extending arms 125 and 126 at the toe end of the female member 46. Thus, the pin 121 may be inter-changeably mountable at either end of the female member 46 depending on whether the picker 60 or the grabber 61 is to be used during the coupling operation to bring the coupling members 45 and 46 together. Within the confines of the female member side plates 107 and 108 and on the female member 46 are two parallel rows of gear teeth 130 that mate with the gear teeth 58 of the male member 45 during coupling of the members 45 and 46.

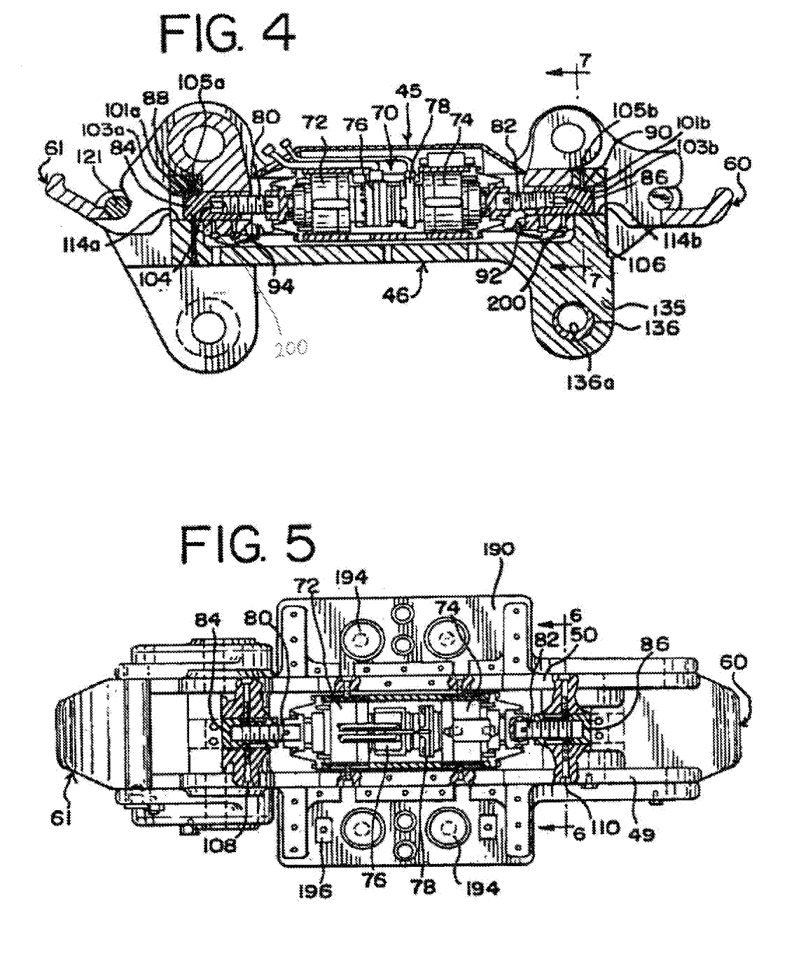

The female coupling member 46, as illustrated, may include pin bosses for pin-connecting the female member to a stick having the standard pin holes. For example, at the underside of the side plates 107 and 108 and the toe end of the female member 46, pin bosses 131 with aligned pin openings 133 may be provided for pin-connection of the toe end of the female member 46 to the stick 18 by means of a pin 134, as shown particularly in FIGS. 1 to 3. At the head end of the female member 46, a single pin boss 135 may be provided and centered to fit between a bifurcated end of the stick 18. An eccentric bushing 136 having a pin hole 136a is received in the pin boss 135, as seen in FIG. 4, and may be adjustably rotated within a circular socket to compensate for minor spacing and/or misalignment differences that may occur in different sticks between the pin hole 136a and a pin 137 that is provided to pin-connect the pin boss 135 to the outer end of the stick 18.

It should be appreciated that the female member could be formed for direct welding or bolting to a stick. One way to weld the female coupling member to the stick would be to cut back part of the end of the stick and eliminate the pin bosses on the female coupling member such that the end of the stick and the underside of the female coupling member were substantially flat. The underside of the female coupling member may also have a wall shaped as a box to facilitate the welding process.

The male coupling member 45 includes a frame having a pair of parallel spaced-apart side plates 49 and 50 connected together near the opposite ends by end walls 51 and 52, as seen in FIG. 12. It will be appreciated that the entire coupling may be made of a suitable steel and that the thickness of the plates 49 and 50 and end walls 51 and 52 is such that as a frame, it may withstand all of the forces subjected to it during the use of the coupling by the heavy-duty machine. The side frame plates 49 and 50 include a mating face 55 and a backside 56. Along the mating face 55 of each of the frame plates 49 and 50 are a series of teeth 58. These teeth 58 may be in the form of gear teeth and take the appearance of a rack gear at each side of the coupling member 45. The mating face 55 is adapted to mate with the mating face 57 of the female member 46.

At the toe end of the male member 45 and also at the backside, pin bosses 272 may be provided at each side plate 49 and 50 for the purpose of providing a pin hole 274 that co-acts with pin holes on the free end of the boom 17 to receive the pin 33 for pin-connecting the lower or toe end of the male member 45 to the end of the boom 17 so that the lower end of the male member 45 may pivotally swing in a vertical direction relative to the end of the boom 17.

Also on the backside of the male member 45 and at an upper or head end thereof, pin bosses 275 may be provided on the inner sides of plates 49 and 50 to define pin holes 275a for co-acting with pin 32 to interconnect one end of the stick cylinder 30 to the upper or head end of the male member 45, whereby actuation of the cylinder 30 will cause pivotal swinging of the male member 45 in a vertical plane. The male coupling member includes at the upper or head end a picker 60 and at the lower or toe end a grabber 61, each of which may guidably assist in bringing together the coupling members 45 and 46 during the coupling operation depending on which end is desired to be used and which end of the female member 46 includes the pin 121.

The picker 60 may include a pair of parallel flat body sections or arms 62 interconnected at ends thereof that culminate in a hook 139 for facilitating the placement of the pin 121 within cavities or slots 140 when the coupling members 45 and 46 are coupled. To maintain the pin 121 within the cavities 140 during the coupling and uncoupling of the coupling members 45 and 46, the picker 60 may include a latch 144 mounted on each arm 62 adjacent to the cavities 140. The latch 144, which is shown on one of the arms 62 of the picker 60 in FIG. 8, is pivotally mounted on pin 147 extending from one side of the male coupling member 45 to a plate (not shown) mounted opposite the side of the male coupling member 45. The latch 144 may include an arcuately-shaped surface 144a such that the front section 148 and the back section 150 of the latch 144 may be engaged by the pin 121 of the female member 46 when the pin 121 is moved within the cavities 140 of the picker 60.

The inner end 152 of the latch 144 includes a pocket or channel 156 for receiving a shot pin or locking pin 158. The locking pin 158, which is slidably received within opposed guides 154, may be spring biased such that the locking pin 158 is biased into the pocket or channel 156 when the channel 156 is aligned with the pin 158. The inner end 152 of the latch 144 and the corresponding end of the guides 154 may be arcuately-shaped to allow the latch 144 to freely rotate into and out of locked position. When the pin 121 is not within the cavities 140 of the picker 60, a torsion spring (not shown) around pin 147 rotates the latch 144 in a counterclockwise direction and biases the back section 150 of the latch 144 upwards into the cavity 140 as shown in phantom in FIG. 8. While a latch on each arm of the picker may be used for additional safety, it is appreciated that one could also use only one latch and not depart from the teachings of the present disclosure. It is also appreciated that a pair of latches may be contained in a latch assembly that fits inside the arms of the picker of the male coupling member.

The latching mechanism may have a proximity sensor 144 located on the outer plate that reads the location of the locking pin 158 to indicate when the latches 144 are properly engaged with the pin 158 in lock position. The sensor 144a is mounted to sense when a divot formed on the side of the locking pin is aligned with the sensor (discussed more below). When the divot and the proximity sensor are aligned, a signal will be sent to the control panel 210 to turn on the “latched” light 222 and indicate that the pin is locked within the cavities of the picker end of the male member.

In operation, when the picker 60 on the male coupling member 45 is used to engage the pin 121 on the female coupling member 46 to begin the coupling process, the boom 17 is maneuvered such that the pin 121 abuts against the end wall 160 on the end of the coupling member 45. The boom may then be maneuvered to allow for the pin 121 to drop down into the cavity 140 of the picker 60. As the pin 121 enters the cavity 140, it will engage the back section 150 of the latch 144 and rotate the latch 144 until the channel 156 is aligned with the spring activated locking pin 158, which will automatically be driven into the channel 156 to lock the latch in place. The locking pin 158 is spring biased by a spring 158a into lock position and connected to a single acting hydraulic cylinder 162, and retractable into unlock position by actuation of the hydraulic cylinder following actuation of a solenoid actuable valve 144b. When the latch is locked or latched in place, the front section 148 of the latch 144 is located within the cavity 140 of the picker and in engagement with the pin to retain the pin 121 within the cavity 140 and latched to the picker end of the male coupling member. Additionally, the proximity sensor on the latching mechanism will send a signal to the control panel 210 to light up the latched light 222. Similarly, when the latching mechanism is unlatched, the unlatched light 224 will be actuated.

When it is desired to separate the coupling members, the solenoid actuated valve 144b suitably located on the coupler or the main chassis of the machine and controlled by depressing a button 212 on the control panel 210, as shown in FIG. 11, selectively feeds pressurized fluid to the hydraulic cylinder for actuating the latching mechanism to release the latch. The solenoid actuates the hydraulic cylinder 162 to retract the locking pin from the latch pocket and drive the spring biased latch to unlatch position and allow the latch to rotate as the female coupling member pin 121 is withdrawn from the picker cavities. As seen in FIG. 8, once the locking pin 158 is released, the pin 121 may be removed from the cavity 140 of the male coupling picker and the back section 150 of the latch 144 will once again be torsionally biased into the cavity. When the locking pin is retracted, the proximity sensor will no longer align with the divot and a signal will be sent to the control panel 210 to light up the unlatched light 224.

For safety reasons, it is preferred that the activation of the hydraulic cylinder to release the locking pin only operate for a short period of time such as ten (10) or twelve (12) seconds. If the pin of the female member has not exited the cavity of the picker in the designated time period, the hydraulic cylinder will de-energize and the spring biased locking pin will move back into the channel to prevent rotation of the latch. The operator can thereafter repeat the uncoupling process if desired. Although the embodiment shown in FIG. 8 is spring-activated and hydraulically-released, it is appreciated that other suitable devices may be utilized to release the locking pin. The latch mechanism on the grabber 61 will operate in the same manner as on the picker 60.

An alternative latching mechanism is shown in FIG. 10 mounted on the picker 60 of the male coupling member 45. This mechanism includes a latch 170 pivotally mounted on a shaft 171 carried by a base plate 176 that is attached to one side of the male coupling member picker 60 through pins or other suitable attaching means 178. The latch 170 includes an arcuately-shaped slotted pin groove 180 receiving a fixed pin 180a that is designed to allow for the limited rotation of the latch 170. A torsion spring 182 normally rotates the latch 170 in a clockwise direction and biases the front end 185 of the latch upward into lock position. A retaining pin 190 is spring-activated to mate with the notch 170a to prevent the downward rotation of the latch in locked position. Once the latch is in lock position as shown in phantom, the pin 121 is prevented from escaping the picker of the male coupling member during the engagement of the coupling members, thereby preventing disengagement and decoupling of the coupling members. When it is desired to disengage the coupling members, the retaining pin 190 may be retracted through the use of a hydraulic actuator or other device to allow for the latch to rotate downward to allow retraction of the pin from the male coupling 45.

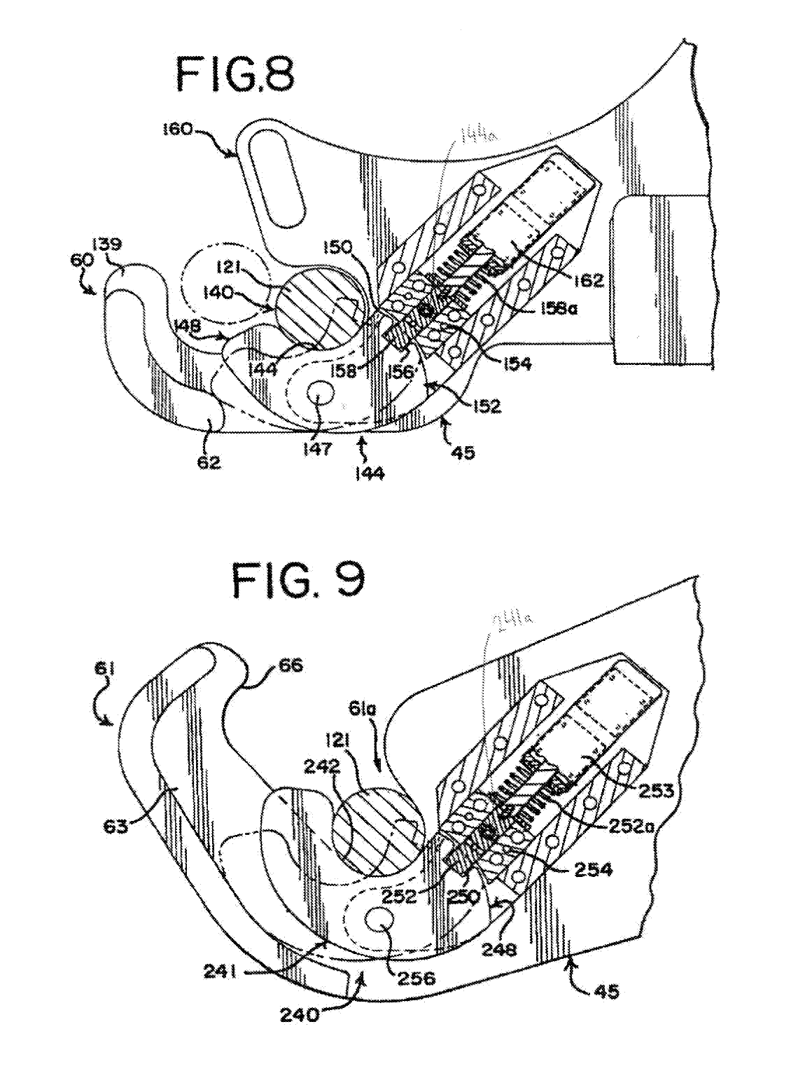

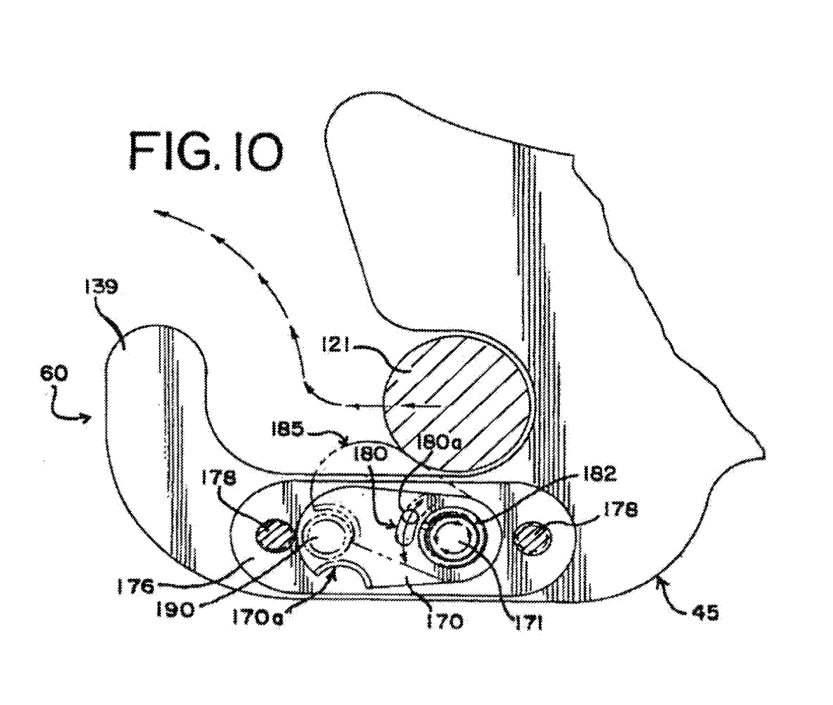

The grabber 61 is mounted at the toe end of the male member to assist in guidably interconnecting the male and female members when the pin on the female member is located at the toe end of the female member. As seen in FIGS. 9 and 12, the end of the grabber 61 defines a pair of spaced apart slotted-shaped hooks 63 that receive the pin of the female member and position the respective ends of the coupling members so the intermeshing elements of each member may matingly engage. Additionally, the hook on the grabber may taper upwards to define a retaining wall 66 to maintain the pin within the grabber during engagement. Preferably, the height of the retaining wall is at least equal to the radius of the pin.

The grabber end 61 also preferably has a pair of latch mechanisms 240, as shown in FIG. 9, to retain the pin 121 within the slots 61a of the grabber end. The latch mechanism includes a hook-shaped latch 241 pivotally mounted on a shaft 256 between one side of the male coupling member 45 and a plate (not shown) parallel to the male coupling member 45. The latch 241 is arcuately-shaped to define a retention slot 242 that may be engaged by the female coupling member pin 121.

The latch 241 includes an inner end 248 having a socket 250 for receiving a shot pin or locking pin 252. The locking pin 252, which is slidably received in guides 254, is preferably spring-activated to be biased into the socket 250 when the socket aligns with the pin. When the pin is not within the grabber, a torsion spring (not shown) around shaft 256 applies a biasing force to the latch in a counterclockwise direction and to the position shown in phantom. It is preferred to have a latch mechanism on each arm of the grabber, although it is appreciated that the pin 121 of the female coupling member could be locked in place on the grabber by a single latch mechanism or by a latch assembly that includes a pair of latches.

The latch on the grabber of the male coupling member, which works the same as the latch shown in FIG. 8 for the picker of the male coupling member, includes a spring 252a that biases the locking pin 252 into engagement with the socket 250 of the latch and the solenoid 144b that actuates a single-action hydraulic cylinder 253 to release the locking pin from the socket. The latch also has a proximity sensor 24 a located on the plate that co-acts with a divot on the locking pin 252 to send a signal to the control panel 210 to indicate the position of the latch. When the divot and the proximity sensor are aligned, a signal will be sent to the control panel 210 to turn on the “latched” light 222a and indicate that the pin is contained within the cavities of the latch.

When the divot moves out of alignment with the proximity sensors, a signal will be sent to the control panel 210 to turn on the unlatched light 224a to indicate that the locking pin 252 is no longer within the socket 250 of the latch. Once the latch is released, the roller pin can exit the cavities to allow the coupling members to be uncoupled.

As seen particularly in FIGS. 4 and 5, the male coupling member 45 includes a locking mechanism 70 to lock the coupling members 45 and 46. The locking mechanism 70 includes a pair of planetary gear assemblies 72 and 74, a motor 76 and a brake 78. The motor 76 is preferably hydraulic, but it could be electrical or any other suitable type if desired. The brake 78, which is preferably hydraulically actuated but may be otherwise actuated if desired, is connected to a shaft on one side of the motor 76. As seen particularly in FIGS. 4 and 5, the planetary gear assemblies 72 and 74, which are connected to and driven by the motor 76 have respectively pin connected thereto Acme threaded shafts 80 and 82, respectively. One of the threaded shafts has right-hand threads while the other threaded shaft has left-hand threads for respectively threadingly engaging and driving wedge-shaped locking bars 84 and 86 into lock and unlock positions. The locking bars may have a ball screw (not shown) in one end that may be filled part way with oil so that the engagement between the shaft and the locking bars are always adequately lubricated. Additionally, the ball screw may have a wiper seal (not shown) on the end to wipe the threads of the threaded shafts 80 and 82 when the shafts are withdrawn from the locking bars.

As shown in FIGS. 4 to 7, the locking bars 84 and 86 are generally cylindrical in shape and provided at their ends with wedge or slanted surfaces 88 and 90, respectfully, that ultimately co-act with sockets 114a and 114b formed on the female member 46. Replaceable wear plates 101a, 101b, and 103a and 103b are preferably provided in the sockets and on the wedge surfaces of the locking bars, respectively. The wear plates are preferably made of a wear-resistant material such as a steel having a hardness on the Shore “A” scale of 50-55. As shown in FIGS. 4 and 7, the socket wear plates 101a and 101b are attached to the sockets by capscrews 105a and 105b. Additionally, the wear plates 103a and 103b on the locking bars 84 and 86 are preferably rounded at the nose of the locking bars to limit the amount of wear. The locking bars 84 and 86 are respectfully slidably guided for reciprocal movement in the cylindrical bores of guide bushings or guideways 92 and 94. As shown in FIG. 12, the outer end of each of the locking bars has a series of threaded bores for attachment of a puller to allow the locking bars to be manually removed if the bars become stuck in their respective sockets after removal of the socket wear plates and disconnection of the Acme threaded shafts from the planetary gearing assembly output shaft. Further, a central hole 85 is provided for a zerk fitting to permit lubrication of the Acme threaded shaft.

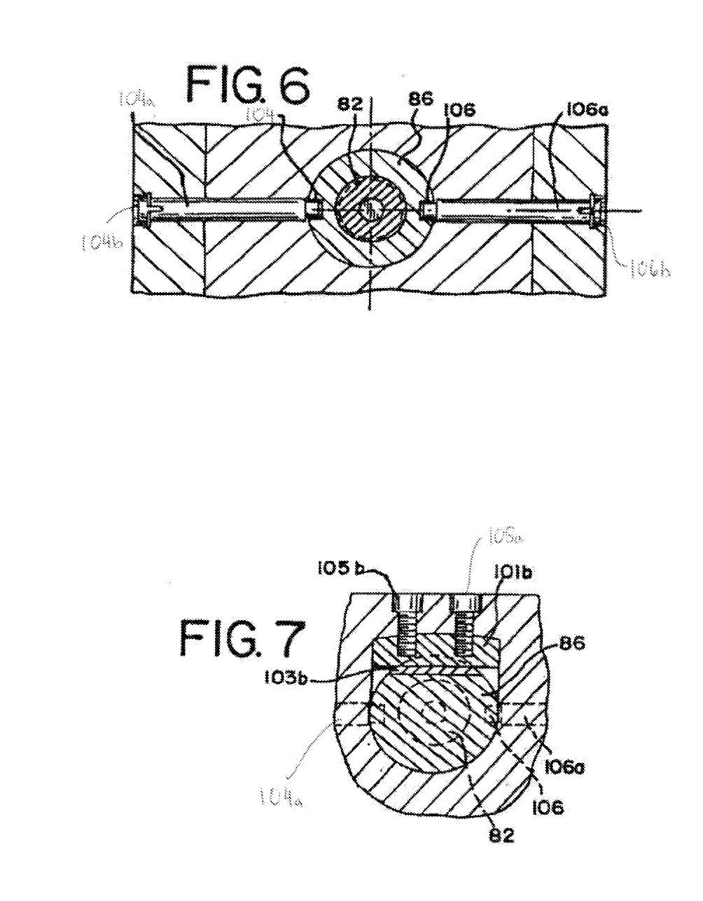

In order to prevent the wedge-shaped locking bars 84 and 86 from rotating in the bushings 92 and 94, the locking bars are respectively provided with diametrically opposed, longitudinally extending keyway slots 104 and 106 at their outer surface that co-act with pins or keys 104a, 104b, 106a, and 106b mounted in the guide bushings. The pins are held in place by lock rings, as seen in FIG. 6. Additionally, the pins 104a, 104b, 106a, and 106b co-act with the slots 104 and 106 to retain the locking bars 84 and 86 in the bushings 92 and 94 and also to stop movement of the bars when one bar separates its socket prior to the other. The brake 78 serves to prohibit the movement of the bars 84 and 86 once the bars are in lock position by prohibiting the rotation of the threaded drive shafts 80 and 82. Thus, the brake serves to stop the bars from both being loosened from or driven further into their respective sockets.

The motor and planetary gear assemblies are slidably mounted on the male member so that if one of the wedge-shaped bars seats before the other, the motor and gear assemblies can slide or float and cause seating of the other wedge-shaped bar so that equal force is applied to both when they are in seated and locked position. Similarly, if one bar unseats or goes to unlock position before the other and is stopped by the pins/slots for that bar, the motor and gear assemblies will float or slide during retraction of the other bar.

As shown in FIGS. 4 and 12, the coupler includes a pair of proximity sensors 200 located on each of the end walls of the male member to detect whether the coupler members are properly locked together by the locking bars. The sensors 200 are spaced apart a distance that corresponds to the distance between a pair of divots 202 on the bottom side of the respective locking bar. The divots are preferably elongated so that they will still activate the proximity sensors if the wear plates on the locking bars and/or the sockets wear down such that the locking bars travel farther into their respective sockets. When all of the divots and the proximity sensors are aligned, a signal will be sent to the control panel 210 to turn on the “locked” light 214 and indicate that the coupling members are properly locked together. In order to help distinguish the “locked” and “unlocked” lights on the control panel, the lights may be of different colors, such as a green light 214 to indicate that the coupling members are locked together and a red light 216 to indicate that the coupling members are unlocked. Additionally, during both the locking and unlocking process, the lights 214 and 216 will flash to indicate that the locking bars are in between locked and unlocked position. It is also appreciated that a sound signal may accompany or take the place of the flashing lights to indicate when the locking mechanism is being operated.

If the “locked” light does not light up, the operator may check to see where the problem might exist by viewing the diagnostic light 218. The diagnostic light will indicate to the operator which locking bar is not properly aligned within its respective socket by the number of flashes, which may be set according to the preference of the operator or otherwise. The diagnostic light can also be used to indicate which locking bar is still locked within the socket when it is sought to unlock the coupling members. For example, one flash can indicate that the picker end is not unlocked, while two flashes can indicate that the grabber end is not unlocked. Similarly, three and four flashes can indicate that the picker end or the grabber end are locked, respectively. The response will depend on whether the operator is attempting to lock or unlock the coupler members.

Also, as particularly shown in FIGS. 5 and 12, plates 190 may be provided on the male member 45 and plates 192 may be provided on the female member 46 for purposes of receiving hydraulic fittings 194 and 195 where it is necessary to provide hydraulic power to a hydraulic cylinder on a stick. The plates, which extend perpendicular to the side plates of the coupling members include hydraulic fittings that align with the respective fittings on the other coupling member so that a hydraulic power connection may be established. While two hydraulic fittings 194 and 195 are shown per side, it is understood that one or more fittings may be utilized as needed, or other types of power couplings, such as pneumatic, hydraulic, electric, and/or mechanical couplings may be utilized. The plates also are preferably fitted with proximity sensors 196, such as 196a and 196b, that are located on the coupling member on the boom side to provide for easy access to a power source (not shown); however, a portable power supply may be used if it is desired to have the sensors on the stick side coupling member. The proximity sensors 196a and 196b are connected to the control panel to actuate a light 220 on the control panel 210 to indicate when the plates 190 and 192 of the coupling member properly come together, thus indicating that the coupling members are properly engaged. While two proximity sensors are shown in FIG. 12, any number of proximity sensors may be used on the plate to indicate when the coupling members are properly mated. Furthermore, the plates may be designed to accommodate pneumatic, hydraulic, electric, and/or mechanical connections as well.

In operation, when the coupling members are properly mated, the proximity sensors 196a and 196b will send a signal to the control panel that will activate the “halves mated” light 220. Once the coupling members 45 and 46 are mated, a control knob 226 on the control panel in the cab 20 can be actuated to operate the motor 76 of the locking mechanism 70. When the locking mechanism is first activated, a locking member solenoid 35a sends a signal that instructs a ball valve 35, shown in FIG. 1, to cut off the flow of fluid to the high pressure line that operates the tool on the stick and redirect the fluid through another hydraulic line to operate the hydraulic motor and brake of the locking mechanism. As the locking mechanism does not require the same pressure and flow as the tools used with the stick, the ball valve also serves to reduce both the flow and pressure of the fluid. Specifically, the ball valve reduces the pressure from about 5,000 psi to between 1,000 and 1,500 psi and reduces the flow from about 92 gallons/minute to about 4 or 5 gallons/minute.

The motor 76 then drives the planetary gear units 72 and 74, which in turn drive the threaded shafts 80 and 82. The use of planetary gear units 72 and 74 generates the necessary torque in the locking mechanism 70 to drive the wedge bars between lock and unlock positions. The shafts will then drive the bars 84 and 86 into sockets 114a and 114b. When the divots 202 on each of the locking bars 84 and 86 are aligned with their respective proximity sensors 200, the “lock” light 214 on the control panel 210 will indicate that the locking bars are properly within the sockets to lock the coupling members together. If both bars are not properly within their respective sockets, a signal will be sent from the proximity sensors to the diagnostic light on the control panel to indicate which bar is not properly engaged. Once the bars are in lock position, brake 78 is actuated to lock the shafts against rotation, and thereby lock the locking bars in lock position. The brake is preferably spring activated and hydraulically released, and will prevent the rotation of the shafts 80 and 82. Once the bars are in lock position, the ball valve 35 will close the line to the locking mechanism and redirect the fluid back to the high pressure line of the stick.

When it is desired to change the stick and tool used by the machine, control 226 is actuated to hydraulically release the brake 78 and operate the motor 76 to retract the bars 84 and 86 from the sockets 114a and 114b so that the coupling members may begin the separation process while still being latched at the picker or the grabber of the male coupling member by retaining the pin of the female coupling member. The unlock light 216 on the control panel will light indicating to the operator the unlock condition of the locking mechanism. Similarly to when the locking mechanism is operated to lock the coupling members together, the controls also serve to send a signal to the ball valve to cut off flow to the high pressure line and redirect the fluid to the motor and the brake. After the locking bars on the male coupling member are retracted from their respective sockets on the female coupling member and the coupling members are rotational separated, the latches may be unlatched by actuation of the unlatch button 212 to allow for the pin to be released from the picker or the grabber and separate the boom from the stick. At this time, the unlatch light 224 or 224a will light, depending on whether the picker or grabber was latched. Further, in order to prevent any accidental damage to the stick or tool and/or its hydraulic cylinder when the stick is placed on the ground, the stick may include a stand 300, as shown in FIGS. 1 to 3, located near the coupling member end of the stick 18.

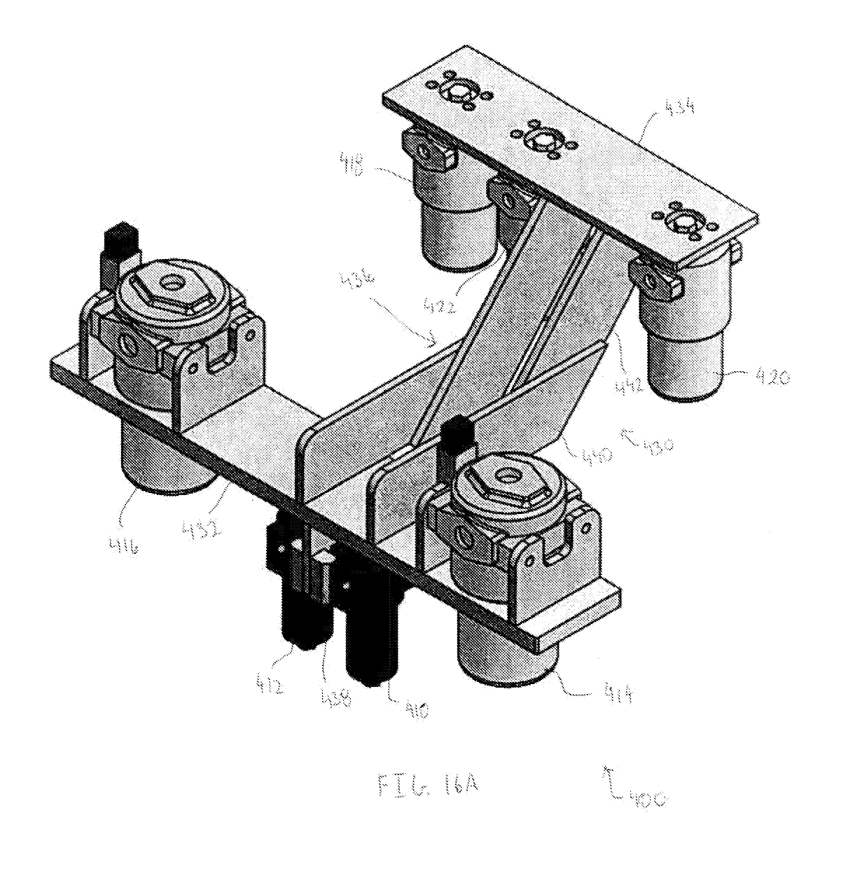

Referring now to FIG. 14, an above perspective view of the heavy-duty machine 16 is shown. In particular, FIG. 14 shows a view of a base of the boom 17 of the heavy-duty machine 16, such as where the boom 17 may be pivotally connected at one end 23 (e.g., the base) to the machine 16. The heavy-duty machine 16 may include one or more hydraulic pumps 310 therein, such as positioned adjacent the base of the boom 17, and further a hydraulic tank 312 may be positioned adjacent the base of the boom 17 and/or the hydraulic pumps 310. Accordingly, a plurality of hydraulic hoses 314 may extend away from the hydraulic pumps 310, such as towards and along the boom 17 and/or towards the hydraulic coupler 15. Further, also included within the heavy-duty machine 16 is a motor/engine filter 316 and a pilot line filter 318, such as shown in FIG. 15. FIG. 15 provides a side perspective view of filters used within a heavy-duty machine 16, in which the filters 316 and 318 may be positioned behind and/or away from the base of the boom 17. The filter 316 may be used to filter oil provided to the motor/engine, such as the motor used to power the hydraulic pumps 310. Further, the filter 318 may be used to filter the pilot line that goes to the controls/joystick in the cab 20 of the heavy-duty machine 16.

As discussed above, hydraulic couplers, such as hydraulically powered quick connect and disconnect couplers, may increase the probability that an operator will switch tools on the heavy-duty machine, and therefore hydraulic couplers may also increase the probability that a hydraulic system of the heavy-duty machine may become contaminated. Accordingly, disclosed herein is a filter system for a hydraulic coupler of a heavy-duty machine. In one embodiment, the filter system may include a filter on each line, such as each fluid flow path, that is equipped and formed with a hydraulic coupler. In particular, a male coupling member of the hydraulic coupler may be coupled to a female coupling member of the hydraulic coupler, thereby fluidly coupling a plurality of fluid flow paths across the hydraulic coupler. The filter system may provide a separate filter for each of the plurality of fluid flow paths, thereby enabling the filter system to filter hydraulic fluid provided through each of the plurality of fluid flow paths. As such, the filter system may be critical for protecting the integrity of the hydraulic system and components of the heavy-duty machine.

Accordingly, in another embodiment, the filter system may include the hydraulic coupler configured to couple a boom of the heavy-duty machine to a stick of the heavy-duty machine, the hydraulic coupler comprising the male coupling member, the female coupling member, and a locking mechanism. A first filter may be used to filter hydraulic fluid provided to a hydraulic motor of the locking mechanism, and a second filter may be used to filter hydraulic fluid received from the hydraulic motor of the locking mechanism. A filter stand may be configured to secure the first filter and the second filter thereto.

Further, the filter system may further include one or more of the following: a third filter that may be used to filter hydraulic fluid provided to an auxiliary component of the stick of the heavy-duty machine; a fourth filter that may be used to filter hydraulic fluid provided received from the auxiliary component of the stick of the heavy-duty machine; a fifth filter that may be used to filter hydraulic fluid provided to a stick cylinder of the heavy-duty machine; a sixth filter that may be used to filter hydraulic fluid received from the stick cylinder of the heavy-duty machine; and/or a seventh filter that may be used to filter hydraulic fluid provided to a component to rotate the stick of the heavy-duty machine. The filter stand may be configured to secure the third filter, the fourth filter, the fifth filter, the sixth filter, and the seventh filter thereto. Further, a filter system in accordance with the present disclosure may include one or more filters, such as up to seven filters discussed above, or more. Accordingly, the present disclosure refers to the filters by numerals, but the present disclosure is not so limited to such particular embodiments, arrangements, or nomenclature, as one having ordinary skill in the art will appreciate that additional or fewer filters may be included and rearranged without departing from the scope of the present disclosure. As such, as the present disclosure refers to a first filter, a second filter, and so forth, such nomenclature is for ease of reference and understanding, as compared to listing filters in order of importance and necessity.

Further, in one or more embodiments, the filter stand of the filter system may include a first cross member, a second cross member, and a support member extending between the first cross member and the second cross member. The filter stand may be positioned adjacent a base of the boom of the heavy-duty machine, and the filter stand may be unenclosed and positioned above a hydraulic pump of the heavy-duty machine adjacent a cab of the heavy-duty machine.

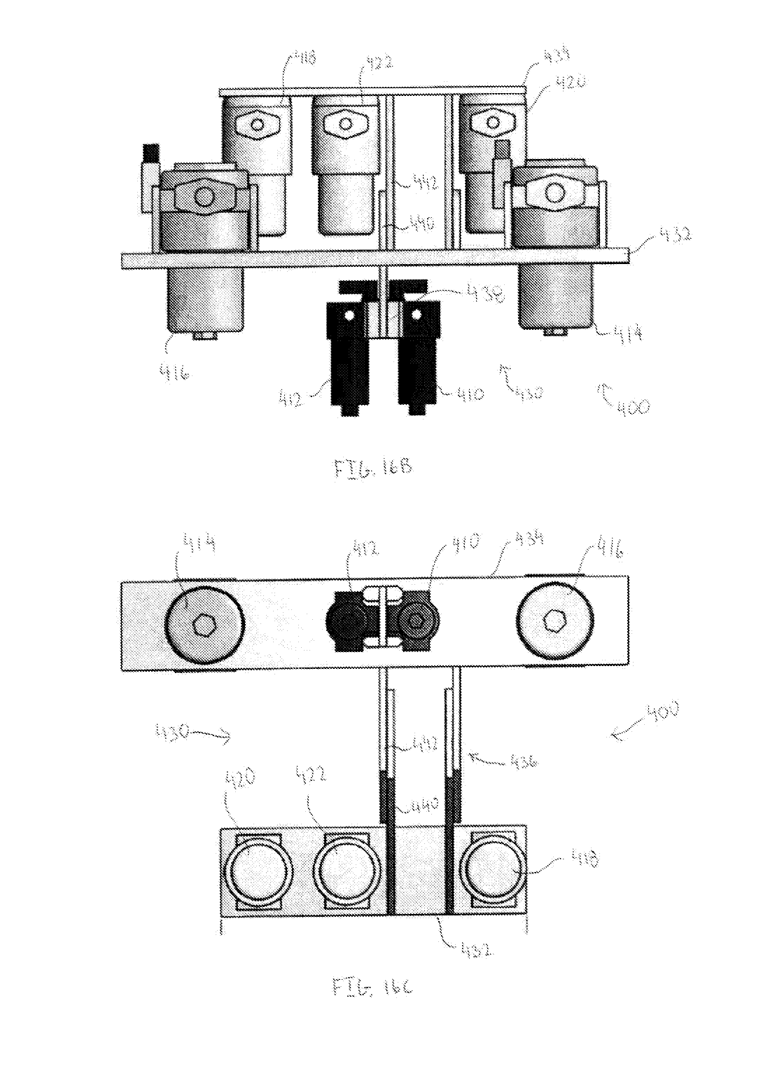

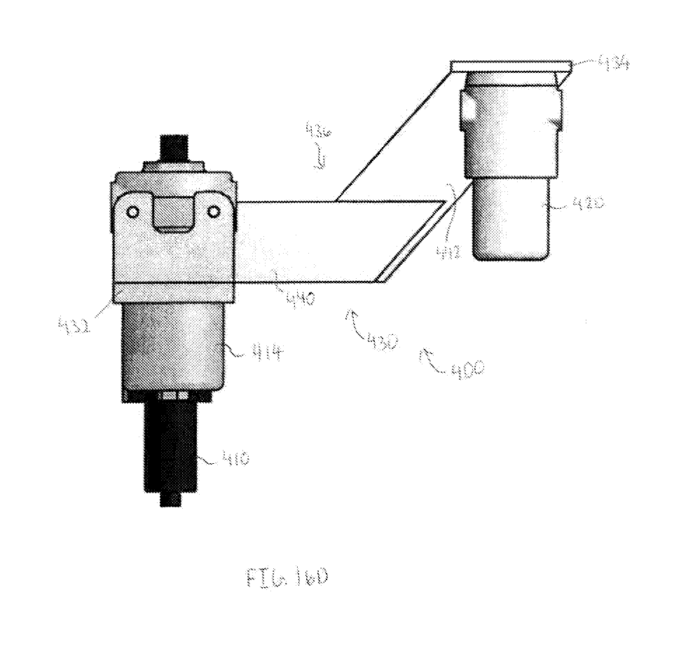

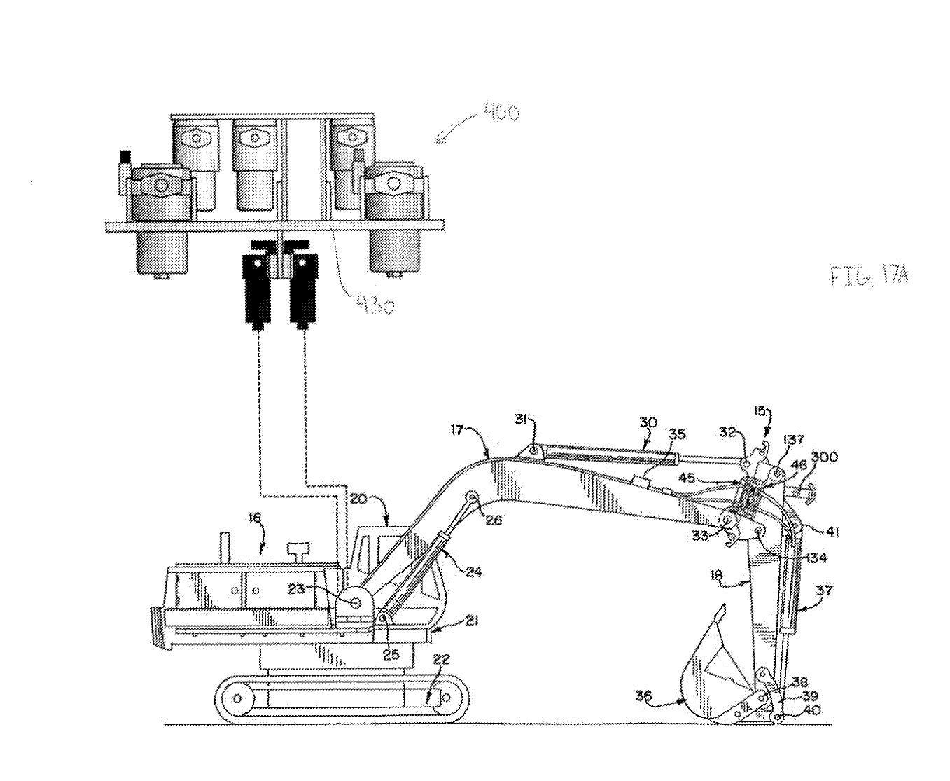

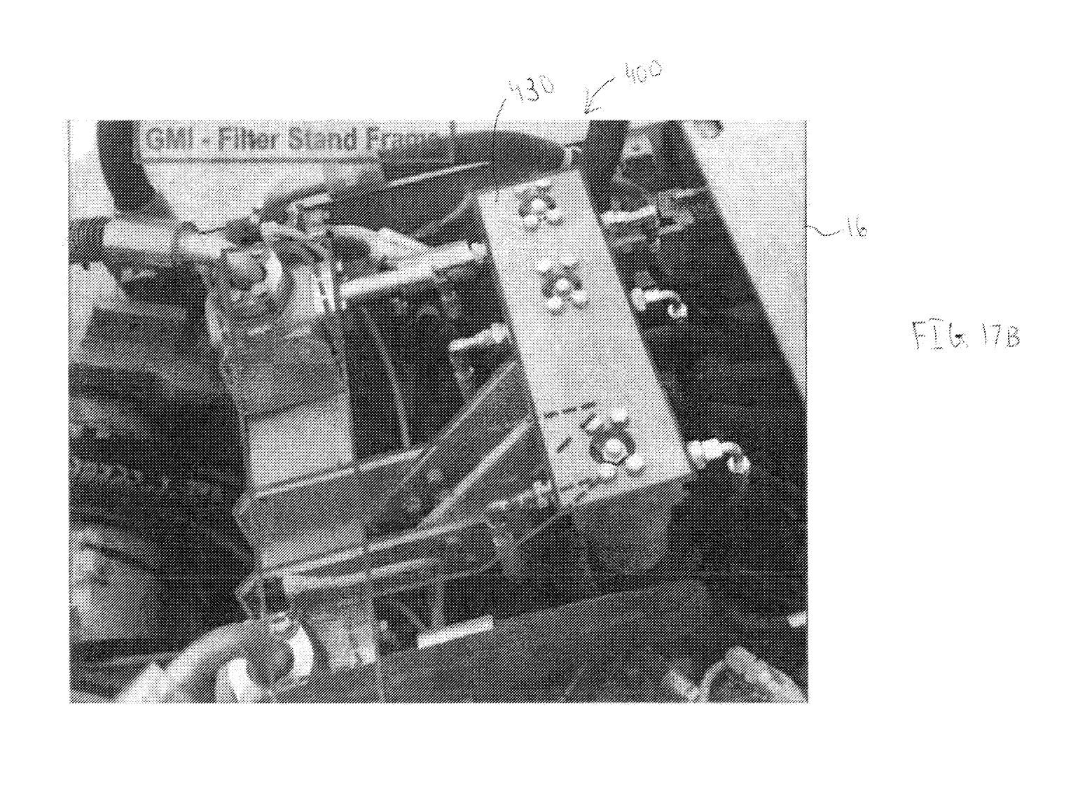

Referring now to FIGS. 16A-16D, multiple views of a filter system 400 in accordance with one or more embodiments of the present disclosure are shown. In particular, FIG. 16A shows an above perspective view of the filter system 400, FIG. 16B shows a front view of the filter system 400, FIG.16C shows an above view of the filter system 400, and FIG. 16D shows a side view of the filter system 400.

As mentioned, the filter system 400 may include a plurality of filters. For example, as shown, the filter system 400 may include a first filter 410 and a second filter 412. The first filter 410 may be fluidly coupled to a first fluid flow path that provides pressurized hydraulic fluid (e.g., powers) to a locking mechanism of a hydraulic coupler, thereby enabling the first filter 410 to filter the pressurized hydraulic fluid provided to the locking mechanism. As such, the first filter 410 may be considered a filter for a hydraulic coupler locking mechanism power fluid flow path. The second filter 412 may be fluidly coupled to a second fluid flow path that receives pressurized hydraulic fluid (e.g., returns) from a locking mechanism of a hydraulic coupler, thereby enabling the second filter 412 to filter the pressurized hydraulic fluid received from the locking mechanism. As such, the second filter 412 may be considered a filter for a hydraulic coupler locking mechanism return fluid flow path.

For example, as discussed above with respect to FIGS. 1-13, the heavy-duty machine 16 may include a quick connect and disconnect coupler, such as a hydraulic coupler 15. As discussed above, one having ordinary skill in the art will appreciate that the quick connect and disconnect coupler may include one or more types of power and/or one or more types of actuators, such as may be hydraulically powered, pneumatically powered, electrically powered, and/or mechanically powered. However, though not to be so limited, the quick connect and disconnect coupler shown within the remainder of the present disclosure is referred to as a hydraulic coupler. Accordingly, the hydraulic coupler 15 may include a locking mechanism 70. A motor 76 of the locking mechanism 70 may be hydraulically powered. As such, the first filter 410 may be used to filter hydraulic fluid provided to the motor 76 through the first fluid flow path, and the second filter 412 may be used to filter hydraulic fluid received from the motor 76 through the second fluid flow path. In one embodiment, when providing hydraulic fluid within a heavy-duty machine for hydraulic power, hydraulic fluid may be provided from a pump, such as adjacent to and/or powered by the motor of the heavy-duty machine, and may then travel through a power supply filter (such as the first filter 410 discussed above). Hydraulic fluid may then continue to travel into and/or through a quick connect and disconnect coupler to the component receiving the hydraulic fluid for power and operation. When receiving hydraulic fluid within a heavy-duty machine for hydraulic power, hydraulic fluid may be received and returned from the component using the hydraulic fluid for power and operation, and into and/or through the quick connect and disconnect coupler. The hydraulic fluid may then continue to travel through a return supply filter (such as the second filter 412 discussed above), and may then continue on to the hydraulic fluid supply, such as the hydraulic fluid tank. This type of power and return fluid flow paths may be used for additional filters, such as for one or more of the filters further discussed below.

Further, the filter system 400 may include a third filter 414 and a fourth filter 416. The third filter 414 may be fluidly coupled to a third fluid flow path that provides pressurized hydraulic fluid (e.g., powers) to an auxiliary component of the heavy-duty machine, thereby enabling the third filter 414 to filter the pressurized hydraulic fluid provided to the auxiliary component. As such, the third filter 414 may be considered a filter for an auxiliary component power fluid flow path. The fourth filter 416 may be fluidly coupled to a fourth fluid flow path that receives pressurized hydraulic fluid (e.g., returns) from an auxiliary component of the heavy-duty machine, thereby enabling the fourth filter 416 to filter the pressurized hydraulic fluid received from the auxiliary component. As such, the fourth filter 416 may be considered a filter for an auxiliary component power fluid flow path. For example, an auxiliary component may be included within a stick of the heavy-duty machine, such as the bucket 36 included within the stick 18 as shown in FIG. 1, in which the auxiliary component is connected to the heavy-duty machine 16 using the hydraulic coupler 15. In another embodiment, an example of an auxiliary component may include a shear (e.g., a rotating shear), a crusher, a grapple (e.g., a rotating grapple), a fork, a drill, a filler/buncher, and/or any other powered work tool that may be used as a stick within a heavy-duty machine. As such, in one embodiment, the third filter 414 and the fourth filter 416 may be used to filter fluid provided to and received from an actuator of the stick 18, such as the bucket-operating cylinder 37 shown in FIG. 1. As such, the third filter 414 and a fourth filter 416 may be fluidly coupled to the auxiliary component through the hydraulic coupler 15.

Furthermore, the filter system 400 may include a fifth filter 418, a sixth filter 420, and a seventh filter 422. The fifth filter 418 may be fluidly coupled to a fifth fluid flow path that provides pressurized hydraulic fluid (e.g., powers) to a stick actuator (e.g., stick cylinder 30) of the heavy-duty machine, thereby enabling the fifth filter 418 to filter the pressurized hydraulic fluid provided to the stick actuator. As such, the fifth filter 418 may be considered a filter for a stick cylinder power fluid flow path. The sixth filter 420 may be fluidly coupled to a sixth fluid flow path that receives pressurized hydraulic fluid (e.g., returns) from a stick actuator of the heavy-duty machine, thereby enabling the sixth filter 420 to filter the pressurized hydraulic fluid received from the stick actuator. As such, the sixth filter 420 may be considered a filter for a stick cylinder return fluid flow path. The seventh filter 422 may be fluidly coupled to a seventh fluid flow path that provides pressurized hydraulic fluid (e.g., powers) to a component that may be used to rotate a boom or stick of a heavy-duty machine, thereby enabling the seventh filter 422 to filter the pressurized hydraulic fluid provided to the rotational component. For example, not only may the stick or the boom of the heavy-duty machine may be used to transverse vertically, but the stick or boom may be able to rotate, or a component thereof, may be able to rotate about an axis thereof. The seventh filter 422 may be used to filter the pressurized hydraulic fluid provided to the rotational component. As such, the seventh filter 422 may be considered a filter for a rotational circuit fluid flow path.

As discussed above, tools used within a heavy-duty machine, such as a hydraulic excavator, may require about 5,000 psi to about 6,000 psi (about 350 bar to about 420 bar) or more of hydraulic pressure for operation. As such, one or more of the filters used within a filter system of the present disclosure may be configured to operate with 5,000 psi, 6,000 psi, or more of hydraulic pressure. For example, the third filter 414 and the fourth filter 416 may be used to operate and filter hydraulic fluid having a hydraulic pressure of about 6,000 psi or more, and the fifth filter 418 and the sixth filter 420 may be used to operate and filter hydraulic fluid having a hydraulic pressure of about 5,000 psi.

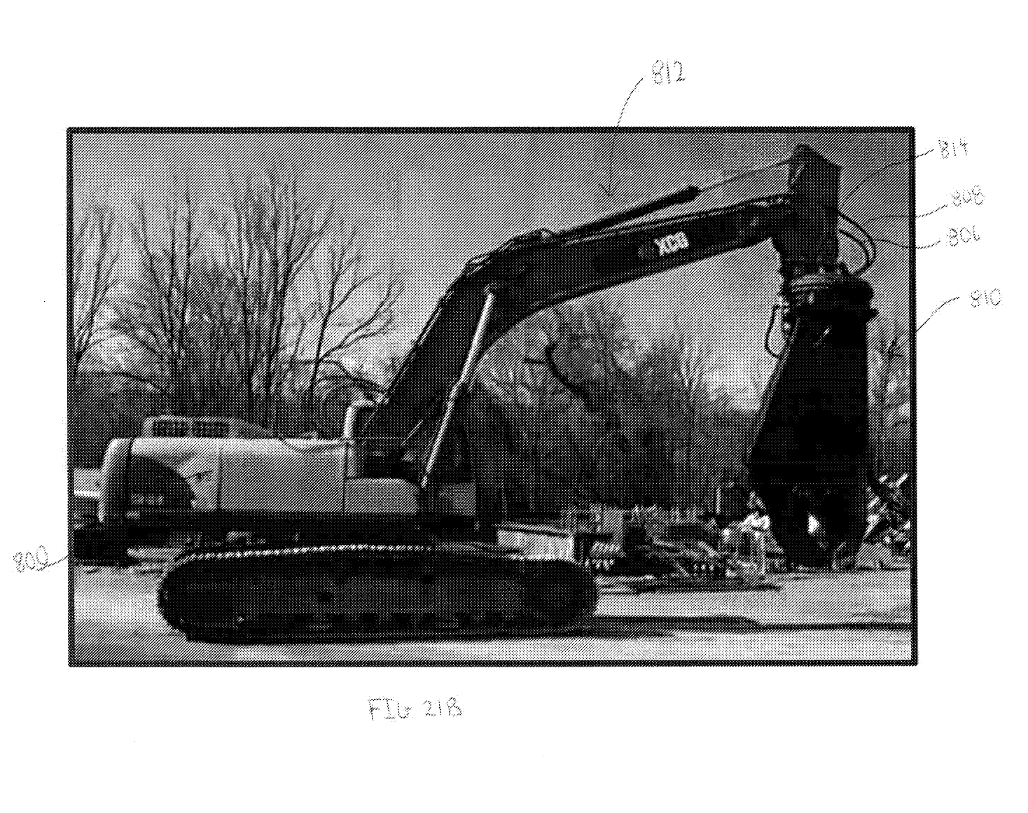

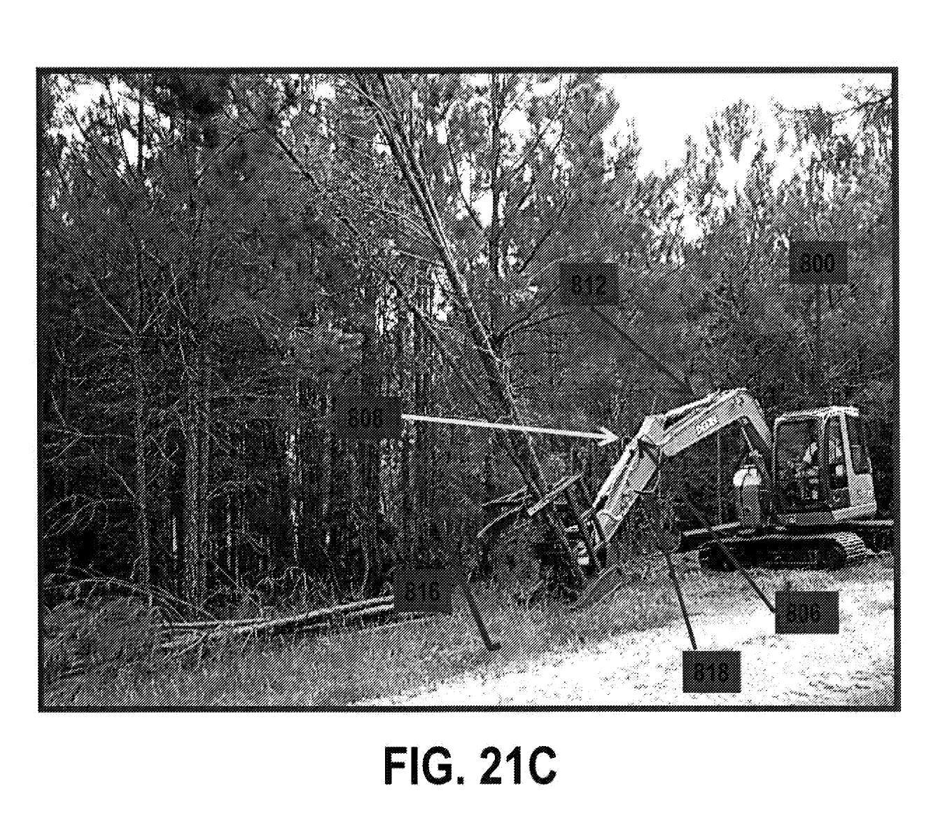

For example, FIGS. 21A-21D show examples of various hydraulic tools for a heavy-duty machine that may be used with a filter system in accordance with one or more embodiments of the present disclosure. FIG. 21A shows a heavy-duty machine 800 that may include a hydraulic hammer 802. The hammer 802 may be movably attached to a stick 804 of the heavy-duty machine 800, in which a power fluid flow line 806 provides pressurized hydraulic fluid to the hammer 802, and a return fluid flow line 808 receives pressurized hydraulic fluid from the hammer 802.

FIG. 21B shows the heavy-duty machine 800 that may include a rotating shear 810. The shear 810 may be movably attached to a boom 812 of the heavy-duty machine 800, in which the power fluid flow line 806 provides pressurized hydraulic fluid to the shear 810, and the return fluid flow line 808 receives pressurized hydraulic fluid from the shear 810. Further, an auxiliary return fluid flow line 814 receives pressurized hydraulic fluid from an auxiliary component of the shear 810, and an additional line, which may be on an opposite side of the boom 812 in the view shown in FIG. 21B, may provide pressurized hydraulic fluid for a rotational component, such as a rotational component to rotate the shear 810.

FIG. 21C shows the heavy-duty machine 800 that may include a feller/buncher saw 816. The feller/buncher saw 816 may be movably attached to the boom 812 of the heavy-duty machine 800, in which the power fluid flow line 806 provides pressurized hydraulic fluid to the feller/buncher saw 816, and the return fluid flow line 808 receives pressurized hydraulic fluid from the feller/buncher saw 816. Further, an auxiliary power fluid flow line 818 provides pressurized hydraulic fluid to an auxiliary component of the feller/buncher saw 816.

Referring still to FIGS. 16A-16D, a filter system 400 in accordance with one or more embodiments of the present disclosure may include a filter stand 430, such as to secure and/or support one or more of the filters 410-422 included within the filter system 400. For example, as shown, the filter stand 430 may include a first cross member 432, a second cross member 434, and a support member 436 extending between the first cross member 432 and the second cross member 434.

The first cross member 432, as shown, may be a lower front horizontal cross member and may be used to support the first filter 410, the second filter 412, the third filter 414, and the fourth filter 416. For example, the first filter 410 and the second filter 412 may be positioned below the first cross member 432, such as by having the first filter 410 and the second filter 412 connected to a bracket 438, in which the bracket 438 may positioned below and extends downwardly from the first cross member 432. Further, the third filter 414 and the fourth filter 416 may be positioned through the first cross member 432, such as on opposite sides of the first cross member 432. The second cross member 434 is shown as an upper back horizontal cross member and may be used to support the fifth filter 418, the sixth filter 420, and the seventh filter 422. As shown, the fifth filter 418, the sixth filter 420, and the seventh filter 422 may be positioned below the second cross member 434, such as connected to a bottom surface of the second cross member 434.

Further, the support member 436 extending between and connected the first cross member 432 and the second cross member 434 may include a first support member 440 and a second support member 442. In particular, as shown in FIGS. 16A-16D, the first support member 440 may include a first pair of support members, and the second support member 442 may include a second pair of support members. As shown, the first support member 440 may be connected to the first cross member 432 and extend therefrom, and the second support member 442 may be connected to the second cross member 434 and extend therefrom. As such, the first support member 440 may be connected to the second support member 442. Those having ordinary skill in the art will appreciate, however, that other arrangements and configurations may be provided for the filter system and the filter stand, such as by having a different arrangement of the filters within the filter stand, by including more or less cross members within the filter stand, and/or included more or less support members within the filter stand, without departing from the spirit of the present disclosure. Further, those having ordinary skill in the art will appreciate that, though the filter system and the filter stand are shown as positioned and located adjacent the base of the boom of a heavy-duty machine, the present disclosure is not so limited, as the filter system and the filter stand may be positioned at other locations within the heavy-duty machine without departing from the scope of the present disclosure.

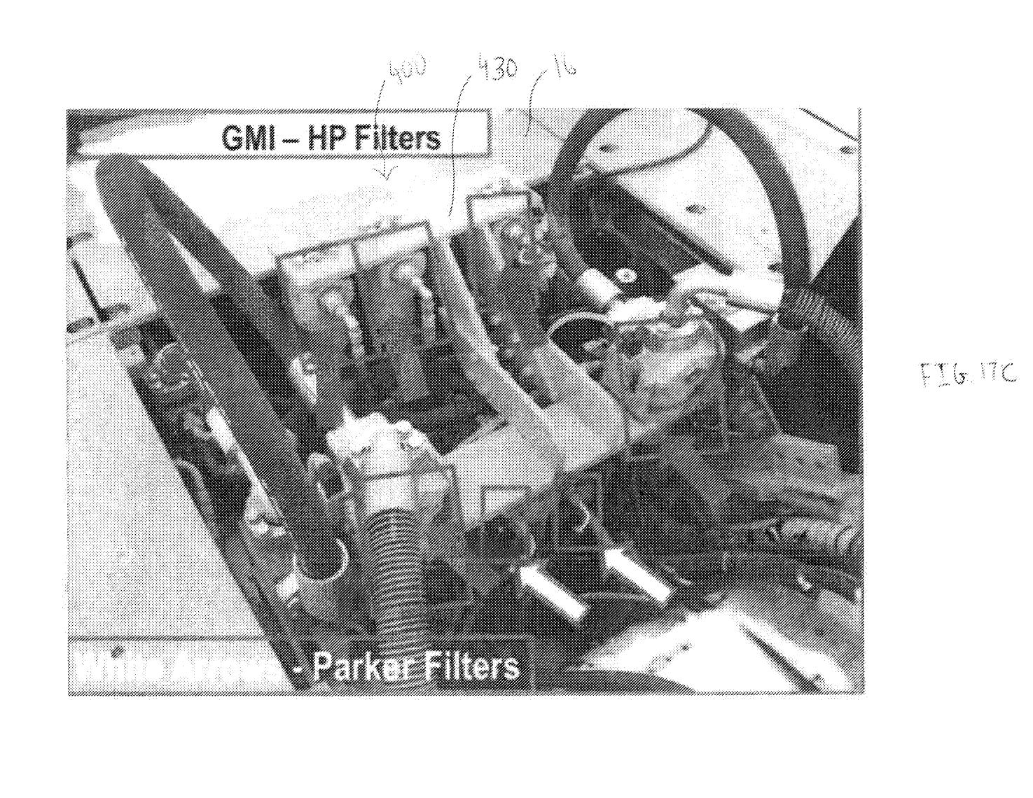

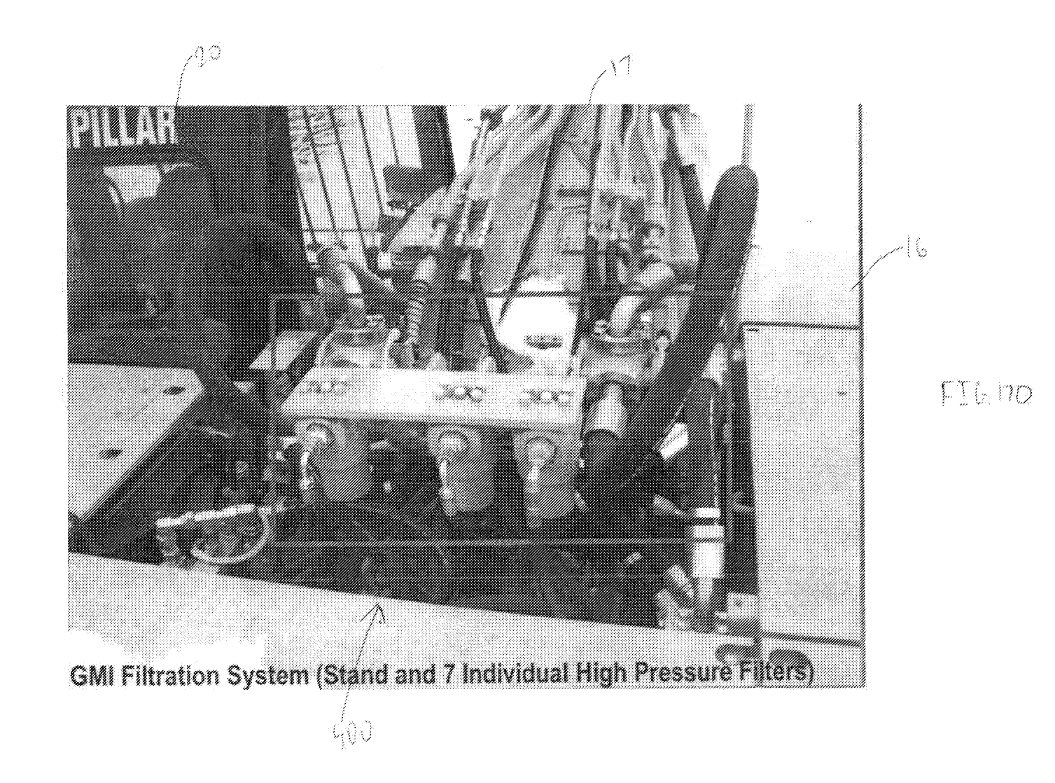

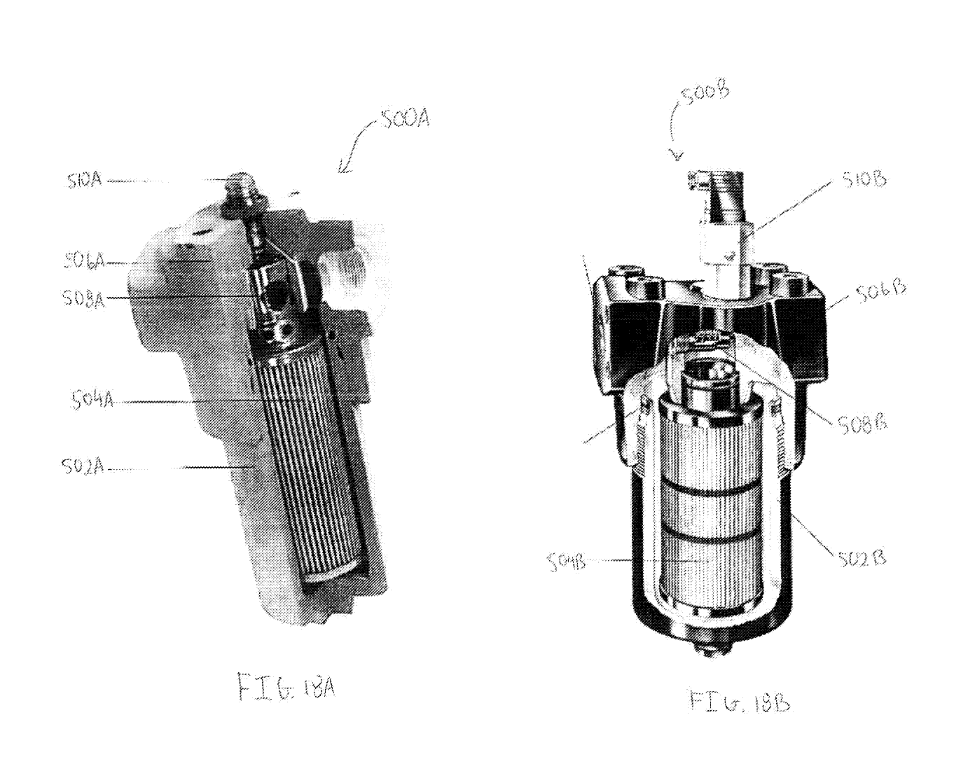

Referring now to FIGS. 17A-17D, multiple perspective views of the filter system 400 included within a heavy-duty machine 16 in accordance with one or more embodiments of the present disclosure are shown. In particular, FIG. 17A shows a schematic view of the filter system 400 included within the heavy-duty machine 16, FIG. 17B shows a side perspective view of the filter system 400 included within the heavy-duty machine 16, FIG. 17C shows a front perspective view of the filter system 400 included within the heavy-duty machine 16, and FIG. 17D shows a back perspective view of the filter system 400 included within the heavy-duty machine 16. As shown in FIGS. 17A-17D, the filter system 400, such as the filter stand 420, may be positioned adjacent the base of the boom 17 of the heavy-duty machine 16. Further, the filter system 400 and the filter stand 420 may be unenclosed, thereby enabling the operator to be able to view the filter system 400 and the filter stand 420 from the cab 20. Furthermore, as shown, the filter system 400 and the filter stand 420 may be positioned over a hydraulic pump of the heavy-duty machine 16, such as the hydraulic pumps 310 shown in FIG. 14.

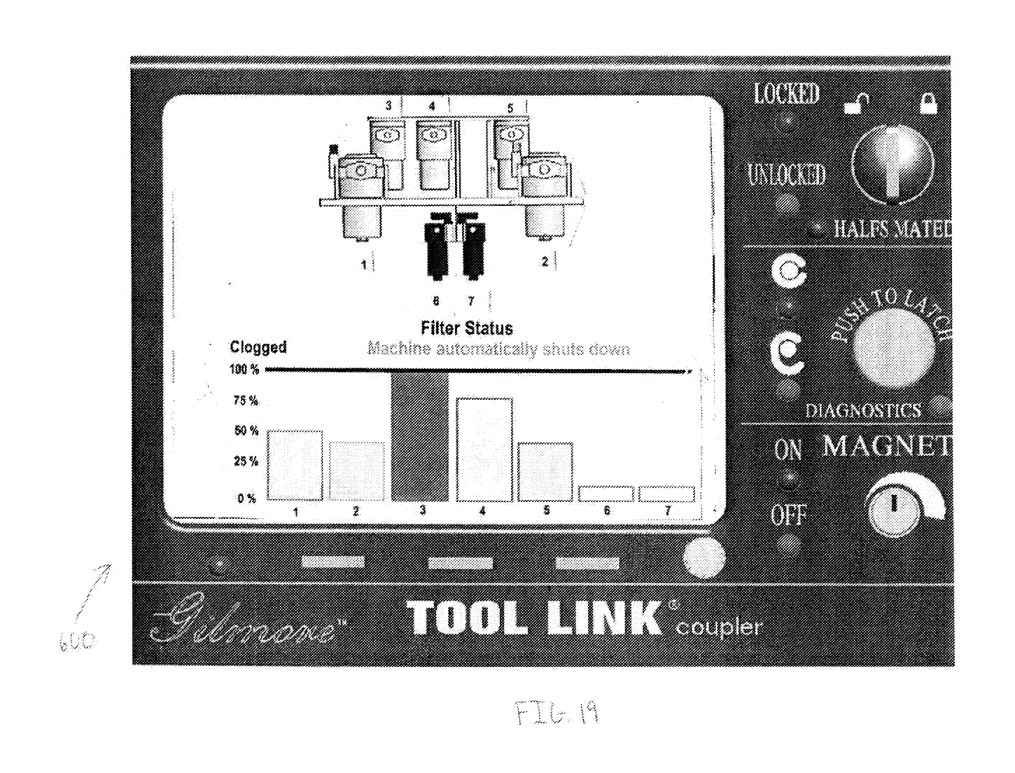

Referring now to FIGS. 18A and 18B, multiple cross-sectional views are provided of filters 500A and 500B in accordance with one or more embodiments of the present disclosure. The filter 500A may include a filter bowl 502A with a filter element 504A positioned therein, in which the filter bowl 502A may be coupled, such as threaded to, a filter head 506A. A filter valve 508A may be positioned within the filter head 506A, and a site indicator 510A may be positioned atop the filter 500A. An example of the filter 500A in accordance with one or more embodiment provided herein is a high pressure filter provided by STAUFF®. Further, the filter 500A may be used for one or more of the filters 410-422, such as for the third filter 414, the fourth filter 416, the fifth filter 418, the sixth filter 420, and the seventh filter 422.

Similarly, the filter 500B may include a filter bowl 502B with a filter element 504B positioned therein, in which the filter bowl 502B may be coupled, such as threaded to, a filter head 506B. In one or more embodiments, the filter element 504B may be formed of a metal, such as stainless steel, and may be capable of filtering hydraulic fluid up to 200 microns. A filter bypass 508B (e.g., spool type valve) may be positioned within the filter head 506B, and a site indicator 510B may be positioned atop the filter 500B. An example of the filter 500B in accordance with one or more embodiment provided herein is a high pressure filter provided by PARKER®. Further, the filter 500B may be used for one or more of the filters 410-422, such as for the first filter 410 and the second filter 412.

As discussed above, a filter system in accordance with one or more embodiments of the present disclosure may include one or more filters fluidly coupled to one or more fluid flow paths. Those having ordinary skill in the art will appreciate that, though only one filter is shown and discussed with respect to each fluid flow path, more than one filter may be included and fluidly coupled to one or more of the fluid flow paths. For example, in one embodiment, rather than only including a first filter fluidly coupled to a first fluid flow path that provides pressurized hydraulic fluid through a quick connect and disconnect coupler, a first plurality of filters (such as two, three, or more filters) may be fluidly coupled to the first fluid flow path that provides pressurized hydraulic fluid through the quick connect and disconnect coupler. In such an embodiment, the plurality of filters may each include a filter element having a different size (e.g., mesh size) that each other, thereby enabling the filters to filter particles of different sizes through the fluid flow path. The plurality of filters may be arranged in series within the fluid flow path, for example, such that the filter having the largest mesh size to filter the particles having the largest size would receive pressurized hydraulic fluid first within the fluid flow path, and so forth, with the filter having the smallest mesh size furthest downstream the fluid flow path. Accordingly, one or more of the filters discussed above, such as any one of the filters 410-422, may instead include a plurality of filters.

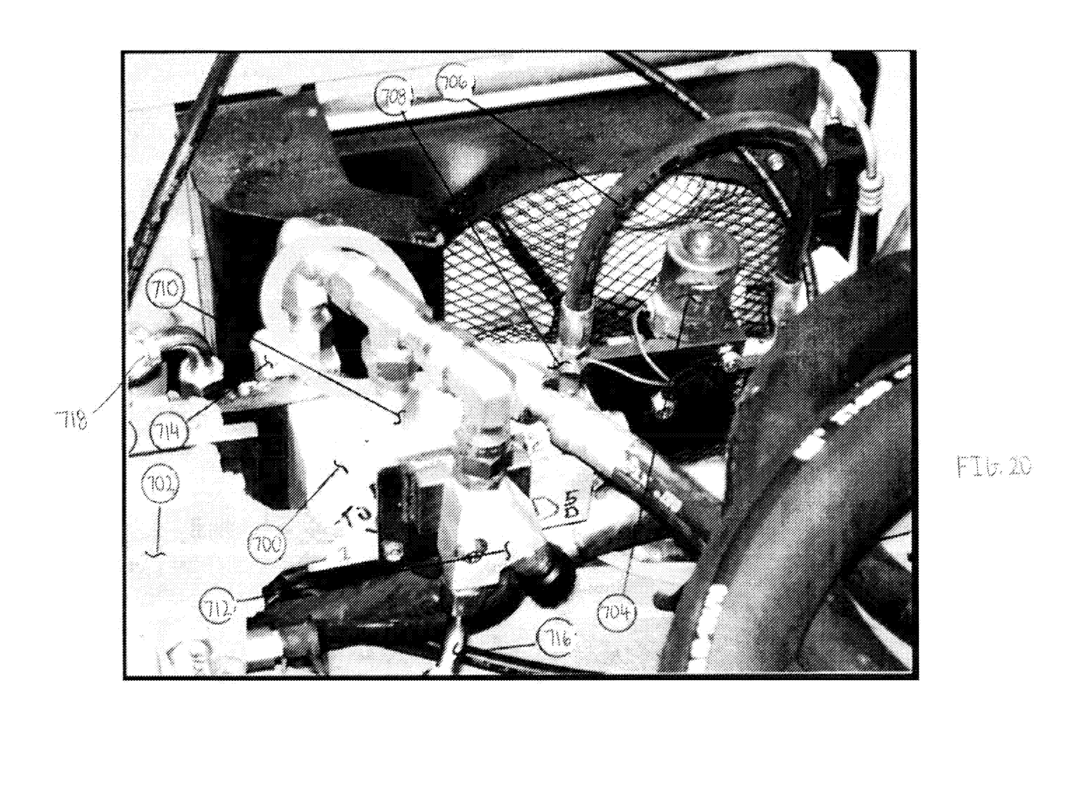

In accordance with one or more embodiment of the present disclosure, a control panel may be operably coupled to one or more filters of a filter system in accordance with the present disclosure. For example, as shown in FIG. 19, a control panel 600 is shown that is operably coupled to one or more of the filters 410-422, in which the control panel 600 may be able to indicate a status or condition of the filters 410-422. For example, the control panel may be electrically and/or electronically coupled to one or more of the filters 410-422, and/or one or more of the fluid flow paths of the filters 410-422. As such, if one of the filters 410-422 is contaminated, faulty, or disconnected, the control panel may indicate to the operator, such as through an indicator light and/or noise, the status of the filters 410-422. For example, a control panel in accordance with one or more embodiments of the present disclosure may be or include a laser particle monitor system. Accordingly, the control panel 600 may be used to disable the heavy-duty machine from use, or at least portions thereof, based upon the status received from the filters 410-422. For example, as shown in FIG. 19, if a filter is shown as completely clogged or contaminated (filter 3 shown as completely clogged in FIG. 19), such as based upon a measured flow or pressure with the filter, the control panel 600 may indicate the status of the filter, and the control panel 600 may disable the heavy-duty machine until the appropriate filter is replaced. In addition, or in alternative to a control panel, one or more of the filters 410-422 may include a site indicator, such as located on top of the filters 410-422. The site indicator may be able to provide a status or condition of the filters 410-422. Further, as the filter system 400 may be located adjacent the cab 20 of the heavy-duty machine 16, the operator may be able to quickly ascertain the status or condition of the filters 410-422.

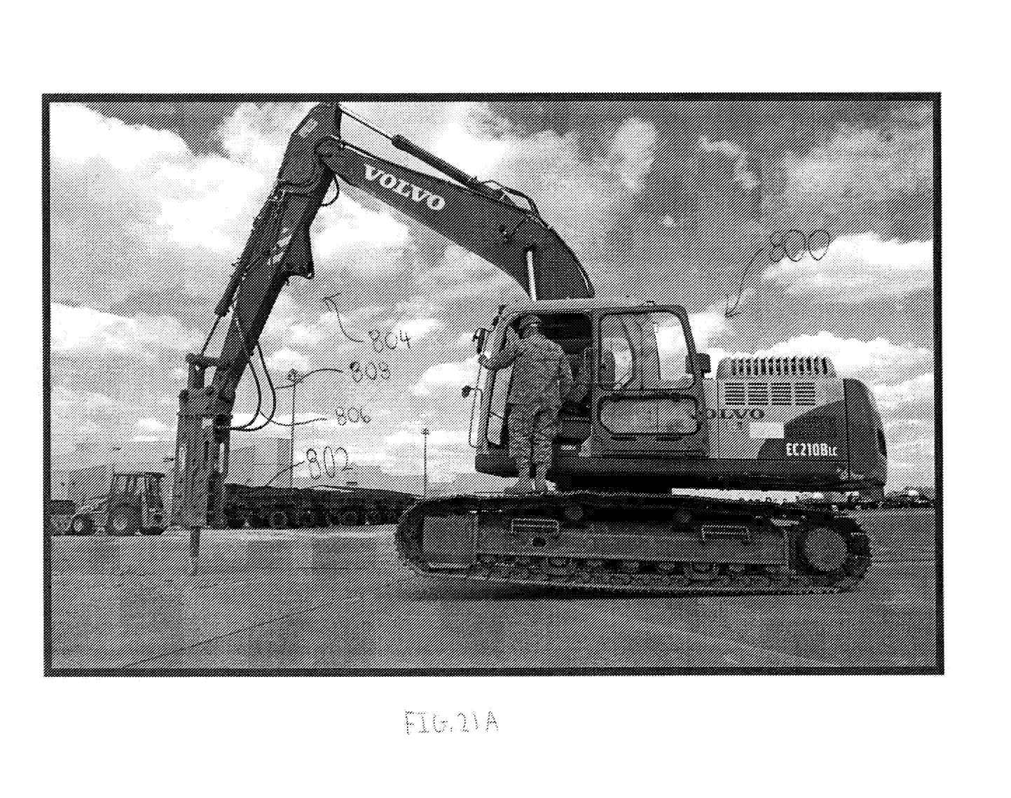

One or more valves may be included within and/or used with a filter system in accordance with the present disclosure, such as using one or more valves to selectively control fluid flow (e.g., amount and/or direction of fluid flow) into and/or out of the filter system, without departing from the scope of the present disclosure. For example, with reference to FIG. 20, a valve 700 that may be used with a filter system in accordance with one or more embodiments of the present disclosure is shown. The valve 700, which may be a diverter valve 700, may be used to restrict and divert some hydraulic fluid flow from reaching a filter and/or component of the filter system and heavy-duty machine altogether. In particular, in one embodiment, hydraulic fluid may be provided at a larger flow rate, such as about 18 gallons per minute, from a hydraulic pump. However, one or more components fluidly coupled and receiving hydraulic fluid from the hydraulic pump many only require and be operable at a smaller flow rate, such as about 5 gallons per minute. For example, one or more components of a quick connect and disconnect coupler, such as the locking mechanism of the hydraulic coupler 15, may operate at lower flow rates. The valve 700 may be used to divert a portion of the flow rate such that operation of components at the smaller flow rate is possible.

In one embodiment, during normal operation when no flow rate restriction may be required, hydraulic fluid may flow through the diverter valve 700 and pass on through to a rotate valve 702. However, when a flow rate restriction or diversion may be required, such as when locking or unlocking the hydraulic coupler 15, hydraulic fluid may be diverted from and through the diverter valve 700. For example, a solenoid valve 704 may be activated. A pilot line 706 may be fluidly coupled between the solenoid valve 704 and the diverter valve 700 to provide pilot pressure through a pilot port 708 to shift a stem of the diverter valve 700. Fluid flow is then diverted to a diverter coupler port 710 of the diverter valve 700 to bypass the rotate valve 702. The diverted flow, such as the flow provided to the hydraulic coupler 15, may then flow through and be adjusted using a needle valve 712. Accordingly, when the hydraulic coupler 15 is activated, such as when locking or unlocking, approximately 5 gallons per minute of hydraulic fluid flow may be routed through the needle valve 712 to operate the locking mechanism of the hydraulic coupler 15, and approximately 13 gallons per minute of hydraulic fluid flow may be routed to the hydraulic fluid supply (e.g., tank) through a relief valve 714 in fluid communication with the diverter valve 700. Accordingly, hydraulic fluid to power the locking mechanism of the hydraulic coupler 15 may be provided through a pressure/power fluid flow line 716, and hydraulic fluid received from the locking mechanism of the hydraulic coupler 15 may be received through a return fluid flow line 718.

In one or more embodiments, an orifice, such as a one millimeter orifice, may be located in the pilot line 706, such as within a fitting that connects to the diverter valve A. The orifice may be used to slow the reaction time of the diverter valve 700, such as to minimize a hydraulic fluid flow spike (e.g., fluid hammer) that may occur when the diverter valve 700 is activated. The relief valve 714 may be a direct acting relief valve also, such as to minimize hydraulic fluid flow spikes when used.

A filter system in accordance with one or more embodiments of the present disclosure may provide one or more of the following advantages. As discussed above, each hydraulic line, such as each hydraulic fluid flow path, may have a filter fluidly coupled thereto. As such, this redundancy may assist in preventing contamination within the hydraulic system of a heavy-duty machine, as opposed to a single hydraulic tank filter that is currently employed within heavy-duty machines. Further, when contamination occurs, the contamination may be isolated to a single source and/or fluid flow path. Each fluid flow path and filter may be monitored, such as using a control panel and/or site indicator, to alert an operator of a condition or status of a filter. Further, the filter system may be unenclosed and positioned on top of the engine housing area and adjacent the cab of the heavy-duty machine for convenient monitoring of the filter system and filters, as compared to positioned inside the hydraulic tank or enclosed within the engine housing area. One or more of the filters may also have a spin-on threaded bowl with a replaceable filter element for convenient maintenance, and may include a lockout valve to eliminate or reduce back wash contamination within the filter system.

Although the present invention has been described with respect to specific details, it is not intended that such details should be regarded as limitations on the scope of the invention, except to the extent that they are included in the accompanying claims.

What is claimed is:

1. A filter system for a heavy-duty machine, comprising:
a filter stand configured to be coupled to the heavy-duty machine;
a first filter supported by the filter stand and configured to be fluidly coupled to a first fluid flow path that provides pressurized hydraulic fluid to an auxiliary component of the heavy-duty machine;
a second filter supported by the filter stand and configured to be fluidly coupled to a second fluid flow path that receives pressurized hydraulic fluid from the auxiliary component of the heavy-duty machine.

2. The filter system of claim 1, further comprising a control panel operably coupled to at least one of the first filter and the second filter to indicate a status thereof.

3. The filter system of claim 2, wherein the control panel is positionable within a cab of the heavy-duty machine, wherein the control panel is electronically coupled to the at least one of the first filter and the second filter, and wherein at least one of the first filter and the second filter comprises a site indicator.

4. The filter system of claim 2, wherein the control panel is configured to disable the heavy-duty machine based upon the status received from the at least one of the first filter and the second filter.

5. The filter system of claim 1, wherein the first filter comprises a first plurality of filters supported by the filter stand and configured to be fluidly coupled to the first fluid flow path in series, and wherein each of the first plurality of filters comprises a filter element of different sizes configured to filter particles of different sizes.

6. The filter system of claim 1, wherein at least one of the first filter and the second filter comprises a replaceable filter element.

7. The filter system of claim 1, wherein the filter stand comprises a first filter stand and a second filter stand with the first filter supported by the first filter stand and the second filter supported by the second filter stand.

8. The filter system of claim 1, wherein the heavy-duty machine includes a quick connect and disconnect coupler, wherein the first filter is configured to provide pressurized hydraulic fluid to the auxiliary component of the heavy-duty machine through the quick connect and disconnect coupler, and wherein the second filter is configured to provide pressurized hydraulic fluid to the auxiliary component of the heavy-duty machine through the quick connect and disconnect coupler.

9. The filter system of claim 8, wherein the quick connect and disconnect coupler comprises a hydraulic coupler, the filter system further comprising:
a third filter configured to be fluidly coupled to a third fluid flow path that provides pressurized hydraulic fluid to a locking mechanism of the hydraulic coupler; and
a fourth filter configured to be fluidly coupled to a fourth fluid flow path that receives pressurized hydraulic fluid from the locking mechanism of the hydraulic coupler.

10. The filter system of claim 9, further comprising:
a fifth filter configured to be fluidly coupled to a fifth fluid flow path that provides pressurized hydraulic fluid to a stick cylinder of the heavy-duty machine;
a sixth filter configured to be fluidly coupled to a sixth fluid flow path that receives pressurized hydraulic fluid from the stick cylinder of the heavy-duty machine; and
a seventh filter configured to be fluidly coupled to a seventh fluid flow path that provides pressurized hydraulic fluid to a component to rotate a stick of the heavy-duty machine.

11. The filter system of claim 1, wherein the filter stand comprises:
a first cross member;
a second cross member; and
a support member extending between the first cross member and the second cross member.

12. The filter system of claim 1, wherein the filter stand is positioned adjacent a base of a boom of the heavy-duty machine, and wherein the filter stand is unenclosed and positioned above a hydraulic pump of the heavy-duty machine.

13. A filter system for a heavy-duty machine including a quick connect and disconnect coupler, comprising:
a filter stand configured to be coupled to the heavy-duty machine;
a first filter supported by the filter stand and configured to be fluidly coupled to a first fluid flow path that provides pressurized hydraulic fluid through the quick connect and disconnect coupler to an auxiliary component of the heavy-duty machine;
a second filter supported by the filter stand and configured to be fluidly coupled to a second fluid flow path that receives pressurized hydraulic fluid through the quick connect and disconnect coupler from the auxiliary component of the heavy-duty machine.

14. The filter system of claim 13, wherein the quick connect and disconnect coupler comprises a hydraulic coupler configured to couple a boom of the heavy-duty machine to a stick of the heavy-duty machine, the hydraulic coupler comprising a male coupling member, a female coupling member, and a locking mechanism, wherein the first filter is configured to provide pressurized hydraulic fluid to the auxiliary component of the heavy-duty machine through the hydraulic coupler, and wherein the second filter is configured to provide pressurized hydraulic fluid to the auxiliary component of the heavy-duty machine through the hydraulic coupler, the filter system further comprising a control panel operably coupled to at least one of the first filter and the second filter to indicate a status thereof.

15. The filter system of claim 14, further comprising:
a third filter configured to provide pressurized hydraulic fluid to a hydraulic motor of the locking mechanism;
a fourth filter configured to receive pressurized hydraulic fluid from the hydraulic motor of the locking mechanism; and
a fifth filter configured to provide pressurized hydraulic fluid to a stick cylinder of the heavy-duty machine;
a sixth filter configured to receive pressurized hydraulic fluid from the stick cylinder of the heavy-duty machine; and
a seventh filter configured to provide pressurized hydraulic fluid to a component to rotate the stick of the heavy-duty machine;
wherein the filter stand is configured to support the third filter, the fourth filter, the fifth filter, the sixth filter, and the seventh filter therefrom.

16. The filter system of claim 15, wherein the filter stand comprises:
a first cross member;
a second cross member; and
a support member extending between the first cross member and the second cross member.

17. The filter system of claim 16, wherein:
the first cross member comprises a lower front horizontal cross member;
at least one of the first filter and the second filter is configured to be positioned below the first cross member;
at least one of the first filter and the second filter is configured to connect to a bracket positioned below the first cross member;
at least one of the third filter and the fourth filter is configured to be positioned through the first cross member;
the second cross member comprises a upper back horizontal cross member;
at least one of the fifth filter, sixth filter, and the seventh filter is configured to be positioned below the second cross member; and
at least one of the fifth filter, sixth filter, and the seventh filter is configured to connect to a bottom surface of the second cross member.

18. The filter system of claim 14, wherein the control panel is positionable within a cab of the heavy-duty machine, wherein the control panel is electronically coupled to the at least one of the first filter and the second filter, wherein at least one of the first filter and the second filter comprises a site indicator, and wherein the control panel is configured to disable the heavy-duty machine based upon the status received from the at least one of the first filter and the second filter.

19. The filter system of claim 13, wherein the filter stand is positioned adjacent a base of the boom of the heavy-duty machine, and wherein the filter stand is unenclosed and positioned above a hydraulic pump of the heavy-duty machine adjacent a cab of the heavy-duty machine.

20. The filter system of claim 13, wherein at least one of the first filter and the second filter comprises a replaceable filter element, and wherein the first filter comprises a first plurality of filters supported by the filter stand and configured to be fluidly coupled to the first fluid flow path in series, and wherein each of the first plurality of filters comprises a filter element of different sizes configured to filter particles of different sizes.

21. A method to filter hydraulic fluid for a quick connect and disconnect coupler of a heavy-duty machine, the method comprising:
coupling a male coupling member of the quick connect and disconnect coupler to a female coupling member of the quick connect and disconnect coupler; and
pumping hydraulic fluid along a first fluid flow path through the quick connect and disconnect coupler to provide hydraulic fluid to an auxiliary component of the heavy-duty machine;
filtering hydraulic fluid pumped along the first fluid flow path with a first filter fluidly coupled to the first fluid flow path;
pumping hydraulic fluid along a second fluid flow path through the quick connect and disconnect coupler to receive hydraulic fluid from the auxiliary component of the heavy-duty machine; and
filtering hydraulic fluid pumped along the second fluid flow path with a second filter fluidly coupled to the second fluid flow path.

22. The method of claim 21, further comprising:
monitoring at least one of the first filter and the second filter with a control panel operably coupled to the one of the first filter and the second filter.
